(19) United States
(12) Patent Application Publication
(10) Pub. No.: US 2026/0173015 A1
(43) Pub. Date: Jun. 18, 2026

(54) INTERNET-OF-THINGS (IOT) BASED POSITIONING

(71) Applicant: QUALCOMM Incorporated, San Diego, CA (US)

(72) Inventors: Zhikun WU, Beijing (CN); Ahmed ELSHAFIE, San Diego, CA (US); Yuchul KIM, San Diego, CA (US); Huilin XU, Temecula, CA (US); Wei YANG, San Diego, CA (US); Linhai HE, San Diego, CA (US)

(21) Appl. No.: 19/124,846

(22) PCT Filed: Nov. 23, 2022
(86) PCT No.: PCT/CN2022/133690

§ 371 Date: Apr. 25, 2025

(51) Int. Cl. H04W 64/00; H04L 67/12

(52) U.S. Cl. CPC H04W 64/00; H04L 67/12

(57) ABSTRACT

Aspects presented herein may enable a wireless device to communicate with a network entity for receiving configurations associated with positioning of an RFID tag. In one aspect, a wireless device transmits a set of requests to a network entity for estimating a range between the wireless device and an IoT device or for estimating a position of the IoT device. The wireless transmits or receives an indication indicating a positioning method for estimating the range between the wireless device and the IoT device or for estimating the position of the IoT device. The wireless device receives at least one response from the network entity including a configuration for a set of resources for estimating the range between the wireless device and the IoT device or for estimating the position of the IoT device based on the set of requests and the indicated positioning method.

### TECHNICAL FIELD

The present disclosure relates generally to communication systems, and more particularly, to a wireless communication involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus transmits a set of requests to a network entity for estimating a range between the wireless device and an Internet of Things (IoT) device or for estimating a position of the IoT device. The apparatus transmits or receives an indication indicating a positioning method for estimating the range between the wireless device and the IoT device or for estimating the position of the IoT device, where the indication is transmitted to or received from the network entity. The apparatus receives at least one response from the network entity including a configuration for a set of resources for estimating the range between the wireless device and the IoT device or for estimating the position of the IoT device based on the set of requests and the indicated positioning method.

In an aspect of the disclosure, a method, a computer-readable medium, and an apparatus are provided. The apparatus receives a set of requests from a wireless device for estimating a range between the wireless device and an IoT device or for estimating a position of the IoT device. The apparatus transmits or receives an indication indicating a positioning method for estimating the range between the wireless device and the IoT device or for estimating the position of the IoT device, where the indication is transmitted to or received from the wireless device. The apparatus transmits at least one response to the wireless device including a configuration for a set of resources for estimating the range between the wireless device and the IoT device or for estimating the position of the IoT device based on the set of requests and the indicated positioning method.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example radio frequency identification (RFID) tag in accordance with various aspects of the present disclosure.

FIG. 6 is a diagram illustrating examples of different types of Internet of Things (IoT) devices in accordance with various aspects of the present disclosure.

FIG. 7 is a diagram illustrating an example of a passive IoT device performing backscattering/reflection of signal with modulation in accordance with various aspects of the present disclosure.

FIG. 8A is a diagram illustrating an example of a network entity communicating directly with an RFID reader in accordance with various aspects of the present disclosure.

FIG. 8B is a diagram illustrating an example of a network entity communicating with an RFID via a relay device in accordance with various aspects of the present disclosure.

FIG. 8C is a diagram illustrating an example of a network entity communicating with an RFID via a relay device in accordance with various aspects of the present disclosure.

FIG. 9 is a diagram illustrating an example of a network entity communicating with a set of IoT devices in accordance with various aspects of the present disclosure.

FIG. 10 is a diagram illustrating an example of estimating the distance between an RFID reader and an RFID tag based on frequency domain (FD)-phase difference of arrival (PDOA) (FD-PDOA) in accordance with various aspects of the present disclosure.

FIG. 11 is a diagram illustrating an example of a network entity configuring a set of resources associated with PDOA positioning for an RFID reader in accordance with various aspects of the present disclosure.

FIG. 12 is a diagram illustrating an example phase value distribution associated with FD-PDOA positioning of an RFID tag in accordance with various aspects of the present disclosure.

FIG. 13 is a diagram illustrating an example of coherent bandwidth and coherent time in accordance with various aspects of the present disclosure.

FIG. 14 is a diagram illustrating an example of an RFID reader determining a location of an RFID tag in accordance with various aspects of the present disclosure.

FIG. 15A is a diagram illustrating an example of a fast-moving RFID reader in accordance with various aspects of the present disclosure.

FIG. 15B is a diagram illustrating an example of a slow-moving RFID reader in accordance with various aspects of the present disclosure.

FIG. 16 is a diagram illustrating an example positioning for IoT devices in accordance with various aspects of the present disclosure.

FIG. 17 is a flowchart of a method of wireless communication.

FIG. 18 is a diagram illustrating an example of a hardware implementation for an example apparatus and/or network entity.

FIG. 19 is a flowchart of a method of wireless communication.

FIG. 20 is a diagram illustrating an example of a hardware implementation for an example apparatus and/or network entity.

### DETAILED DESCRIPTION

Aspects presented herein may enable a network entity to configure a radio frequency identification (RFID) reader to estimate/determine the position or the distance of an RFID tag based on phase difference of arrival (PDOA) positioning. For example, when an RFID reader (e.g., a UE) is configured to locate/determine the position of an RFID tag and the RFID reader is also capable of communicate with a network entity (e.g., a base station), the RFID reader may send a positioning request to the network entity. Based on the positioning request, the network entity may configure one or more parameters associated with the PDOA positioning for the RFID reader, such as the frequency and/or time resources, the bandwidth, and/or the number of repetitions for the PDOA positioning.

Aspects presented herein may improve the positioning efficiency and accuracy of an RFID tag performed by an RFID reader. In one aspect, the RFID reader may indicate to a network entity at least one positioning method it is configured to use (e.g., received signal strength indicator (RSSI)-based positioning, PDOA-based positioning, time difference of arrival (TDOA)-based positioning, etc.), such as via a reader positioning request. In response, the network entity may provide suitable configuration(s), such as resource allocations, for the RFID reader based on the indicated positioning method(s) (e.g., via a network positioning response). In another aspect, as different positioning methods may specify different positioning precisions, an RFID reader may also report/indicate its positioning precision demand to a network entity, rather than explicitly indicating different positioning methods to the network entity (e.g., via a reader positioning request). In response, the network entity may provide suitable configuration(s) for the RFID reader (e.g., via a network positioning response) based on the positioning precision demand. In some examples, besides RFID reader deciding the positioning method(s), the network entity may also be configured to determine at least one positioning method for the RFID reader, such as via an L1/L2/L3 signaling or the network positioning response.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TR P), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IA B) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

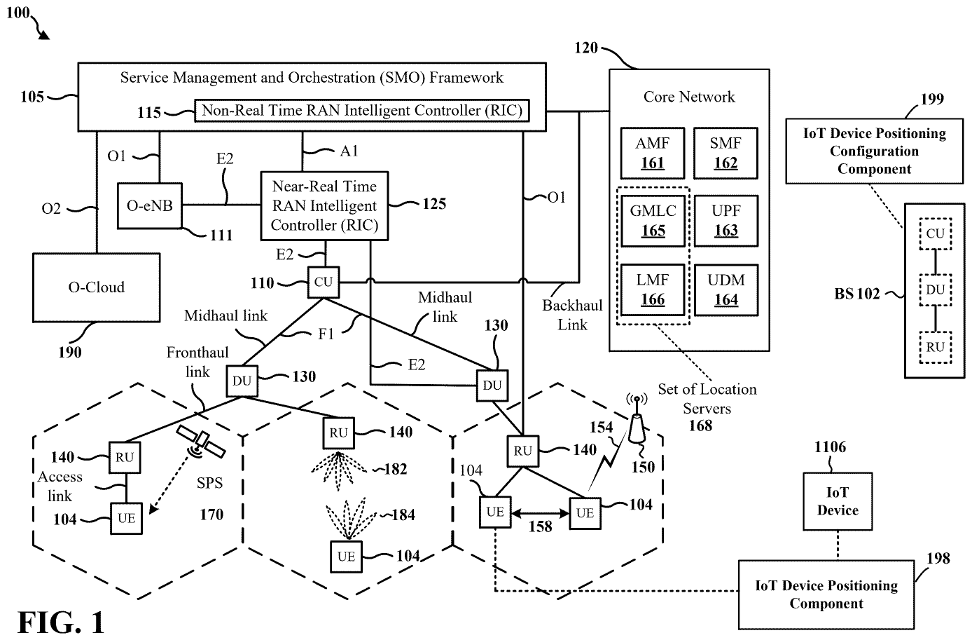

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RA configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRA CH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eN B (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ A I/M L models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of YxMHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHZ-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHZ-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SM F) 162, a User Plane Function (UPF) 163, a Unified Data Management (UDM) 164, one or more location servers 168, and other functional entities. The A M F 161 is the control node that processes the signaling between the UEs 104 and the core network 120. The AMF 161 supports registration management, connection management, mobility management, and other functions. The SM F 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GM LC 165 and the LMF 166 support UE location services. The GM LC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NRE-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to transmit a set of requests to a network entity for estimating a range between the wireless device and an IoT device or for estimating a position of the IoT device; transmit or receive an indication indicating a positioning method for estimating the range between the wireless device and the IoT device or for estimating the position of the IoT device, where the indication is transmitted to or received from the network entity; and receive at least one response from the network entity including a configuration for a set of resources for estimating the range between the wireless device and the IoT device or for estimating the position of the IoT device based on the set of requests and the indicated positioning method (e.g., via the IoT device positioning component 198). In certain aspects, the base station 102 may be configured to receive a set of requests from a wireless device for estimating a range between the wireless device and an IoT device or for estimating a position of the IoT device; transmit or receive an indication indicating a positioning method for estimating the range between the wireless device and the IoT device or for estimating the position of the IoT device, where the indication is transmitted to or received from the wireless device; and transmit at least one response to the wireless device including a configuration for a set of resources for estimating the range between the wireless device and the IoT device or for estimating the position of the IoT device based on the set of requests and the indicated positioning method (e.g., via the IoT device positioning configuration component 199).

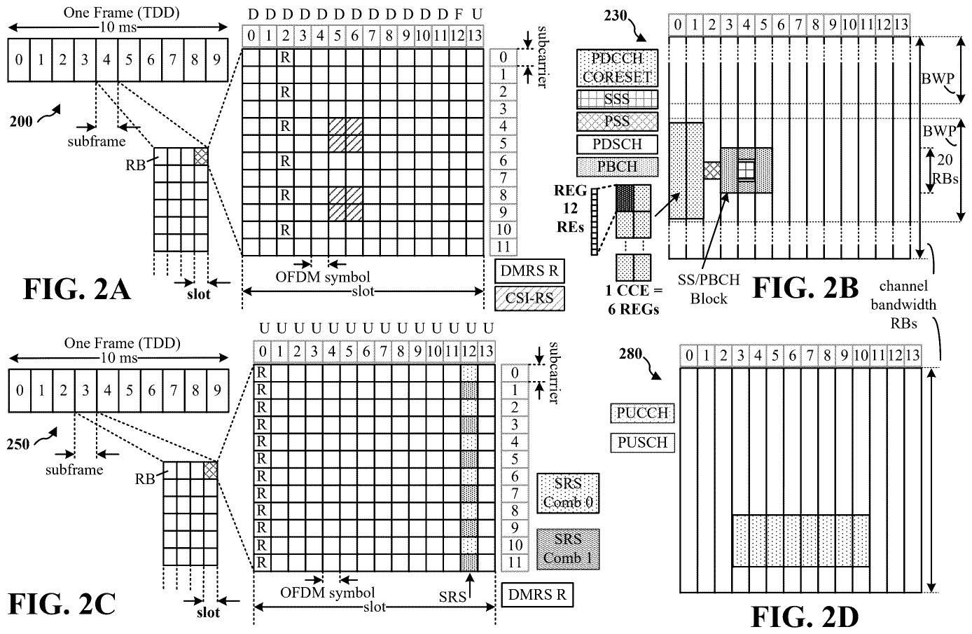

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PB CH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

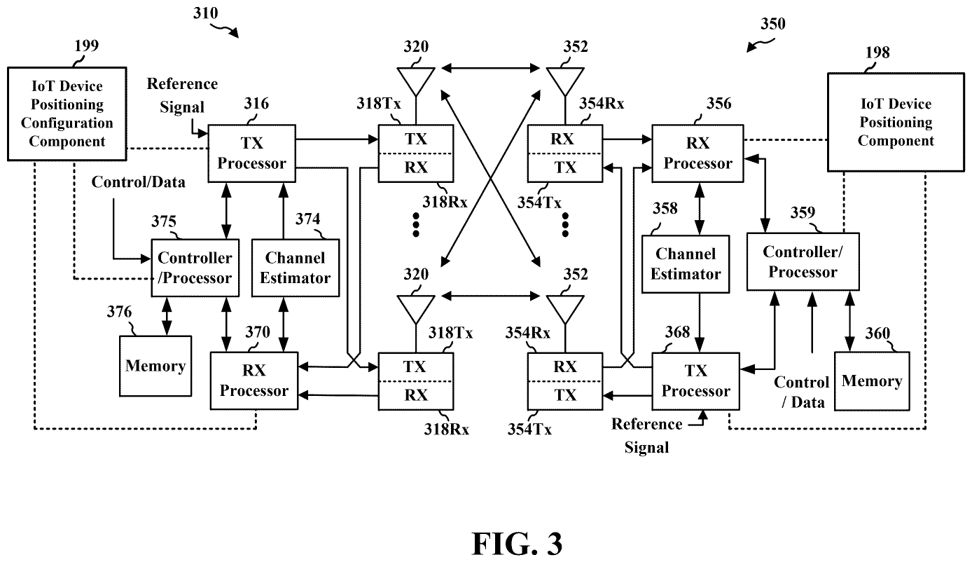

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PD Us, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the IoT device positioning component 198 of FIG. 1.

At least one of the TX processor 316, the RX processor 370, and the controller/processor 375 may be configured to perform aspects in connection with the IoT device positioning configuration component 199 of FIG. 1.

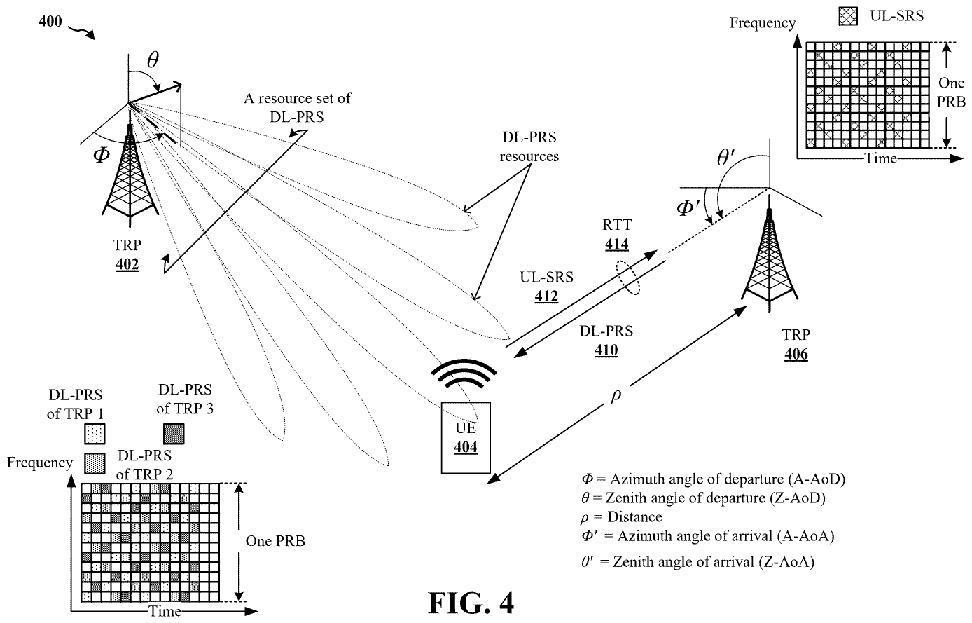

FIG. 4 is a diagram 400 illustrating an example of a U E positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SR Ss) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RToA) (and/or UL SRS-RSRP) at multiple TRPs 402, 406 of uplink signals transmitted from UE 404. The TRPs 402, 406 measure the UL-RToA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

In some scenarios, the positioning of an object may be performed using an Internet-of-Things (IoT) device, such as by attaching an IoT device on the object and measuring signals backscattered/reflected from the IoT device. For example, one or more wireless devices (e.g., a UE, a base station, a component of a base station, a transmission reception point (TRP), or a combination thereof) may transmit signals to an IoT device (e.g., a device to be tracked or is attached to an object to be tracked), and the one or more wireless devices may receive signals reflected/backscattered (which may be referred to as “backscattered signal(s)” hereafter) from the IoT device and measure the received backscattered signal(s). For example, the one or more wireless devices may measure the round-trip time (RTT), the time of arrival (ToA), the angle of arrival (AoA), and other positioning related measurements described in connection with FIG. 4, etc., of the backscattered signal(s) (which may collectively be referred to as “positioning measurements” hereafter). Based on the positioning measurements for the backscattered signals, the position and/or the relative position of the IoT device may be calculated, estimated, and/or determined. A relative position of an IoT device may refer to the position of the IoT device with respect to another device or entity, such as a UE or a base station. For example, the relative position of an IoT device may be ten (10) meters from a base station, east of the base station, etc. For purposes of the present disclosure, an IoT device may refer to a device that is capable of wirelessly connecting to a network and have the ability to transmit data. For example, an IoT device may be a piece of hardware, such as a sensor, an actuator, a gadget, an appliance, or a machine, that is programmed for a certain application and is capable of transmitting data over the Internet or other networks.

In some examples, an IoT device may be referred to as a radio frequency identification (RFID), an RFID tag (or simply a tag), an RFID device, a passive RFID, a backscatter-based RFID, or a backscatter-based IoT, etc. (collectively as an “RFID tag” or a “passive IoT device” hereafter). RFID may refer to a form of wireless communication that incorporates the use of electromagnetic or electrostatic coupling in the radio frequency portion of the electromagnetic spectrum to uniquely identify an object, an animal, or a person, etc. A device that is capable of reading information transmitted from an IoT device may be referred to as a backscatter receiver, a backscatter reader, an RFID reader, an RFID reader UE, and/or a reader UE, etc. (collectively as an “RFID reader” hereafter). In addition, the wireless device that transmits signals to the IoT devices (which may be a different entity than the RFID reader) may be referred to as an RF source, an RF source UE, or a carrier emitter. Note that a wireless device/entity may be capable of both transmitting signals to an IoT device and receiving reflected signals (e.g., readings) from the IoT device, which may be referred to as full-duplex devices. As such, an RF source may also be an RFID reader and vice versa.

RFID is a rapidly growing technology impacting many industries due to its economic potential for inventory/asset management (e.g., asset tracking, asset monitoring, etc.) in both indoor and outdoor environments, such as inside or outside of a warehouse, for IoT, for sustainable sensor networks in factories and/or agriculture, and for smart homes, etc. In addition, some IoT devices may be operated without an internal power source, where these IoT devices may be referred to as zero power (ZP)-IoT (ZP-IoT) devices in some examples. ZP-IoT devices are capable of relying on energy harvesting and passive communication (or low power communication) technologies, such as backscatter communication. With such technologies, low power and low cost IoT devices may be achieved. For example, in some commercial communication systems, ultra-high frequency radio frequency identification (UHF RFID) systems has been mature and widely used around the world, which is also based on backscattered communication. However, the UHF RFID systems may be configured to work in an industrial, scientific and medical (ISM) band, while other telecommunication systems, such as NR systems, may work in a licensed band.

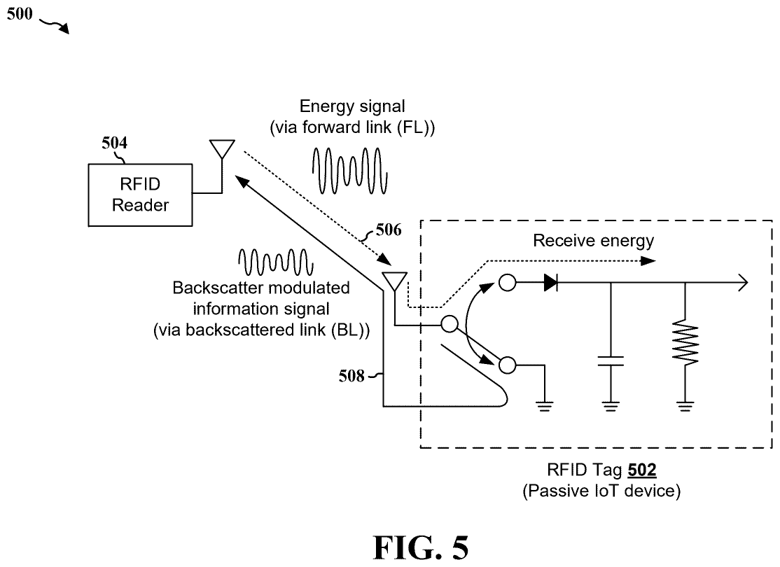

FIG. 5 is a diagram 500 illustrating an example RFID tag, which may also be a zero power IoT device, in accordance with various aspects of the present disclosure. An RFID tag 502 (e.g., a passive/ZP-IoT device) may include small transponder(s) emitting an information-bearing signal upon receiving a signal (e.g., from an RFID reader 504). The RFID tag 502 may operate without a battery at a low operating expense (OPEX), at a low maintenance cost, and/or with a long-life circle. As shown at 506, the RFID tag 502 may absorb/harvest energy over the air based on the energy signals transmitted from the RFID reader 504 (e.g., via a forward link (FL)) to power its transmission/reception circuitry. Then, as shown at 508, the RFID tag 502 may use the absorbed/harvested energy to transmit (e.g., reflect/backscatter) an information signal (e.g., a signal that contains information, a 1-bit indication, a multi-bit indication, etc.) to the RFID reader 504 (e.g., via a backscattered link (BL)), where the transmitted information signal may be typically backscatter modulated (e.g., modulated based on the signals received form the RFID reader 504). There may also be RFID tags with batteries (which may be referred as semi-passive or active RFID tags), which typically have higher cost compared to RFID tags without batteries.

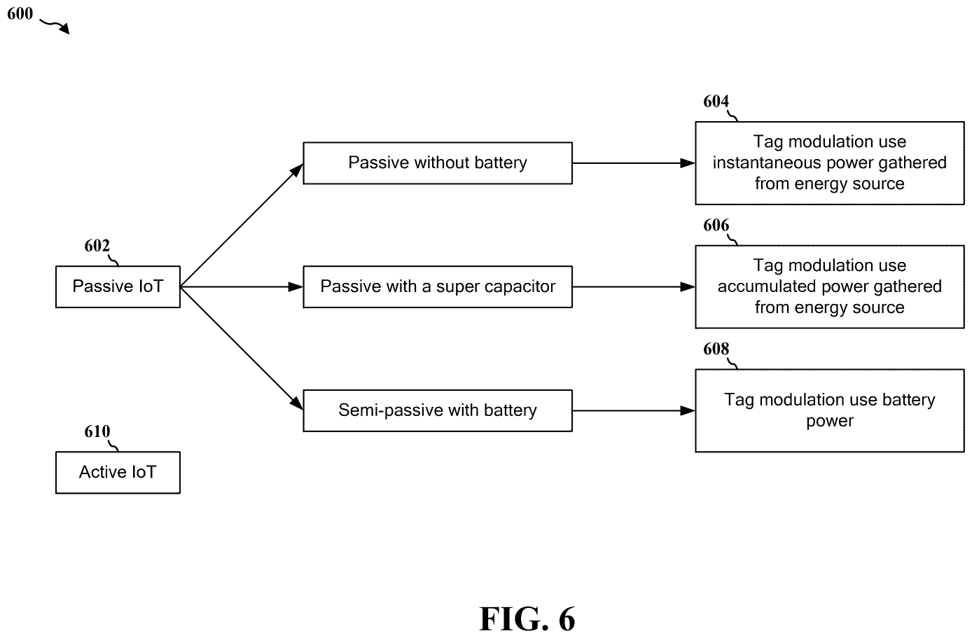

FIG. 6 is a diagram 600 illustrating examples of different types of IoT devices (e.g., RFID tags) in accordance with various aspects of the present disclosure. An IoT device may be configured to be a passive IoT device or an active IoT device. For example, as shown at 604, a passive IoT device 602 (e.g., a ZP-IoT device) may not have a battery in its terminal, but its terminal may accumulate (e.g., absorb or harvest) energy from radio signaling (e.g., transmitted from a base station, an RF source, a wireless device, a UE, etc.). In another example, as shown at 606, the passive IoT device 602 may include a super capacitor, where the terminal of the passive IoT device 602 may accumulate energy from other source(s) of energy, such as solar, wind, thermoelectric, etc., as supplement. In another example, as shown at 608, the passive IoT device 602 may be configured to be semi-passive with a battery, which may enable the passive IoT device 602 to modulate/transmit signals using the power from the battery, and the passive IoT device 602 may be able to activate almost all the time but may not transmit actively. For a passive IoT device, a user may connect to it and receive information from it. On the other hand, an active IoT device 610 may transmit information as a timed, a threshold, and/or a constant stream (e.g., may be performed without first receiving a signal from an RF source). For example, an active IoT device or a semi-active IoT device may include an amplification capability and/or active RF components, which may enable the IoT device to transmit better quality transmission/information.

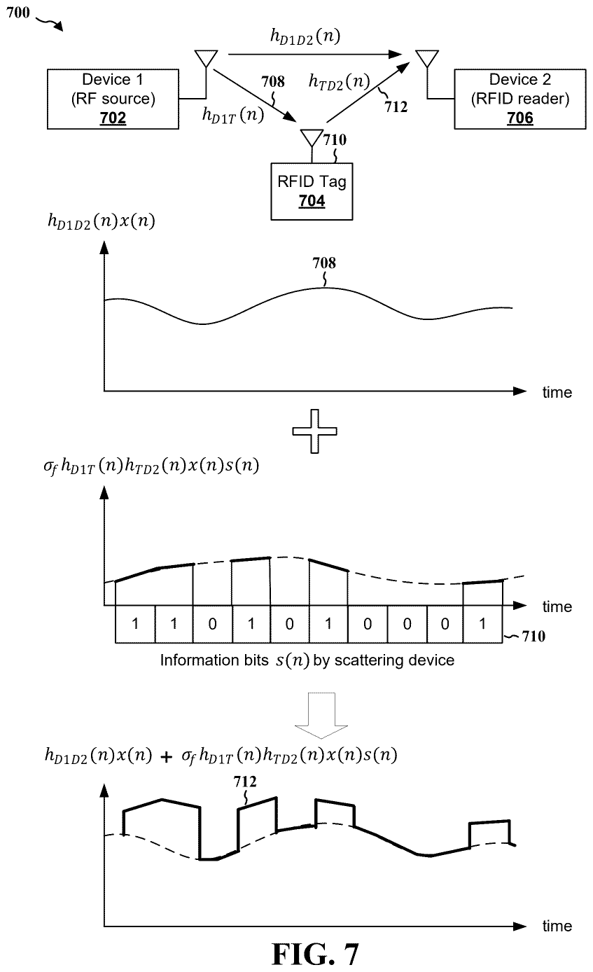

FIG. 7 is a diagram 700 illustrating an example of a passive IoT device (e.g., an RFID tag) performing backscattering/reflection of signal with modulation in accordance with various aspects of the present disclosure. In one example, one of the major information modulation methods used by a passive IoT device (e.g., an RFID tag 704) may be amplitude shift keying (ASK), where the passive IoT device may be configured to switch on the reflection when transmitting information bit ‘1’ and switch off the reflection when transmitting information bit ‘0’.

For example, as shown at 708, a first device 702 (e.g., an RF source, a first UE or a network entity that is capable of transmitting RF waves) may transmit a certain radio wave denoted as x(n), which is to be received by an RFID tag 704 (e.g., a passive IoT device, an RFID reader, etc.). As shown at 710, the information bits of the RFID tag 704 may be denoted as s(n)∈{0,1}. Then, as shown at 712, the received signal y(n) at a second device (e.g., a second UE, an RFID reader, etc.) may be denoted by y(n)=(h_{D1D2}(n)+σ_{f}h_{D1T}(n)h_{TD2}(n)s(n))x(n)+noise. Note the first device 702 and the second device 706 may also be the same device, which may be referred to as a full-duplex device). In one example, when s(n)=0, the RFID tag 704 may be configured to switch off the reflection (e.g., the RFID tag 704 does not transmit any signal), such that the second device 706 may just receive a direct link signal from the first device 702 (e.g., y(n)=h_{D1D2}(n)x(n)+noise). However, when s(n)=1, the RFID tag 704 may be configured to switch on the reflection, such that the second device 706 may receive a superposition of both the direct link signal and the backscatter link signal (e.g., y(n)=(h_{D1D2}(n)+σ_{f}h_{DIT}(n)h_{TD2}(n)s(n)) x(n)+noise, such as shown at 712, where of may denote the reflection coefficient).

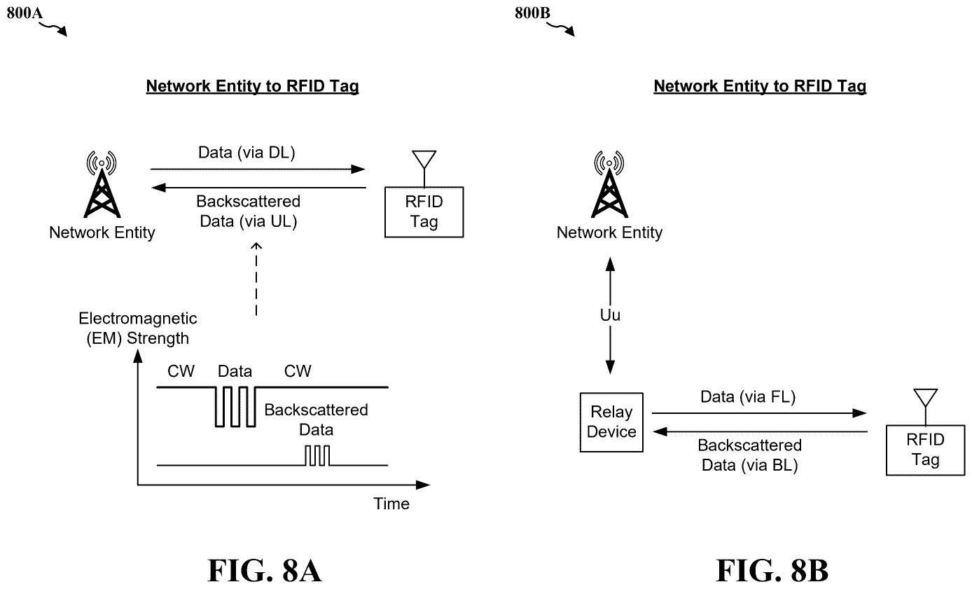

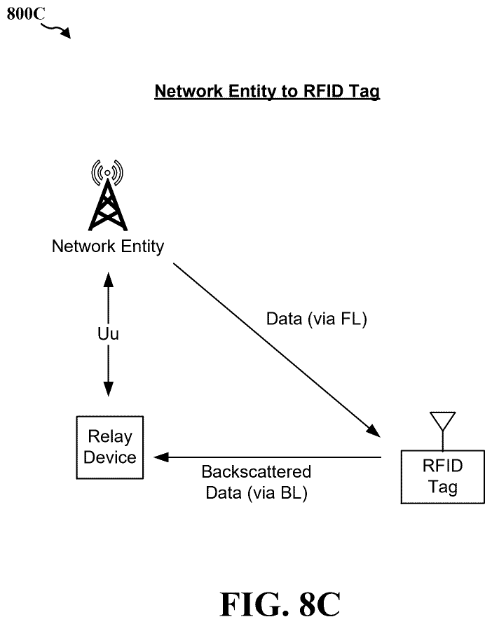

FIG. 8A is a diagram 800A illustrating an example of a network entity (e.g., a base station) communicating directly with an RFID reader in accordance with various aspects of the present disclosure. In some examples, a network entity, such as a base station or a transmission reception point (TRP), may be configured to transmit an energy signal (e.g., data) to an RFID tag directly (e.g., via a DL). Then, upon receiving the energy signal, the RFID tag may backscatter the energy signal and transmit the backscattered energy signal (e.g., backscattered data) to the network entity (e.g., via an UL).

FIG. 8B is a diagram 800B illustrating an example of a network entity (e.g., a base station) communicating (indirectly) with an RFID via a relay device in accordance with various aspects of the present disclosure. In some examples, a network entity, such as a base station or a TRP, may obtain information of an RFID tag via a relay device (e.g., a UE, an RFID reader, etc.). For example, the network entity may request the relay device to transmit an energy signal (e.g., data) to an RFID tag (e.g., via a forward link (FL)). Upon receiving the energy signal from the relay device, the RFID tag may backscatter the energy signal and transmit the backscattered energy signal (e.g., backscattered data) to the relay device (e.g., via a backscattered link (BL)). Then, the relay device may relay/forward the received backscattered energy signal to the network entity.

FIG. 8C is a diagram 800C illustrating an example of a network entity (e.g., a base station) communicating (indirectly) with an RFID via a relay device in accordance with various aspects of the present disclosure. In another example, a network entity, such as a base station or a TRP, may transmit an energy signal (e.g., data) to an RFID tag (e.g., via a FL). Upon receiving the energy signal from the network entity, the RFID tag may backscatter the energy signal and transmit the backscattered energy signal (e.g., backscattered data) to a relay device (e.g., via a BL). Then, the relay device may relay/forward the received backscattered energy signal to the network entity (e.g., via a Uu link).

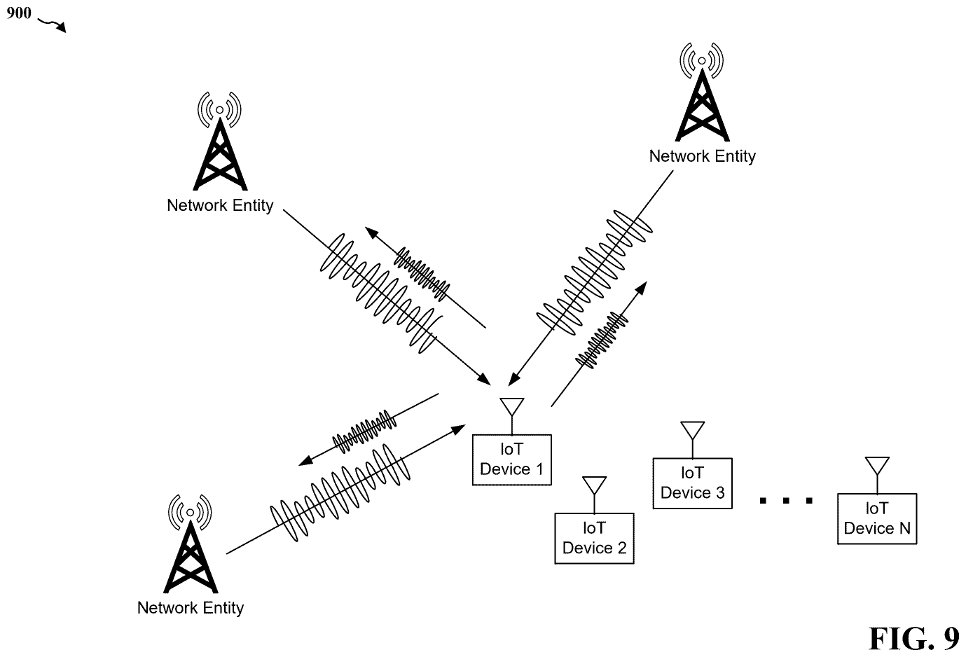

FIG. 9 is a diagram 900 illustrating an example of a network entity communicating with (e.g., receiving information from) a set of IoT devices in accordance with various aspects of the present disclosure. In some examples, the network entity may be a relay node, a RAN node, a non-RAN node, an IAB node, a base station, a component of a base station, etc. As wireless communication (e.g., 5G NR) has been expanding to support different types of wireless devices, such as enhanced mobile broadband (eMBB) devices, ultra-reliable low latency communications (URLLC) devices, and/or machine type communications (MTC) devices, etc., it is likely that the wireless communication may also be expanded to support IoT devices such as passive IoT devices. While a network may not yet be able to efficiently support certain pervasive RFID-type of sensors (e.g., passive IoT devices) in certain scenarios, e.g., asset management, logistics, warehousing, and manufacturing, etc. A next generation network may be specified to support or manage passive IoT devices, where a network entity (e.g., a base station, a component of a base station, an IA B node, etc.) may be configured/specified to provide energy to the passive IoT devices and/or read/write information stored on passive IoT devices. For example, the passive IoT devices may reflect/backscatter information-bearing signals to the network entity, and the network entity may read the reflected/backscattered signal by passive IoT devices to decode the information transmitted by the passive IoT devices. In another example, multiple network entities may transmit signals to an IoT device (e.g., the IoT device 1) and receive the signal backscattered/reflected from the IoT device. Based on the RTT or ToA of the backscattered signal, each of the multiple network entities may calculate/estimate a distance/angle between that network entity and the IoT device. As such, the position of the IoT device may be determined (e.g., based on trilateration/triangulation mechanisms).

As described in connection with FIGS. 4, 5, and 9, the position or the relative position of an IoT device may be determined based on measuring backscattered signals transmitted from the IoT device at one or more network entities (e.g., base station(s), UE(s), etc.). For example, a network entity (e.g., a base station, a component of a base station) may transmit positioning reference signals (PRSs) to an IoT device and measure the PRSs backscattered/reflected from the IoT device. Similarly, a UE may transmit PRSs or sidelink (SL) signals to the IoT device and measure the PR Ss/SL signals backscattered/reflected from the IoT device. Base on the measurements, the position of the IoT device may be determined.

In some scenarios, phase difference of arrival (PDOA) measurement may be suitable for positioning of a ZP-IoT device. Under PDOA, the position of an IoT device may be estimated based on the phase differences between the transmitted signal and the backscattered signal. For example, an RFID reader may transmit signals in different frequencies to a RFID tag, and the RFID tag may backscatter these signals in different frequencies. Based on the backscattered signals, the RFID reader may compare the phase difference at those different frequencies, and the RFID reader may determine/estimate the distance between itself and the RFID tag based on the comparison.

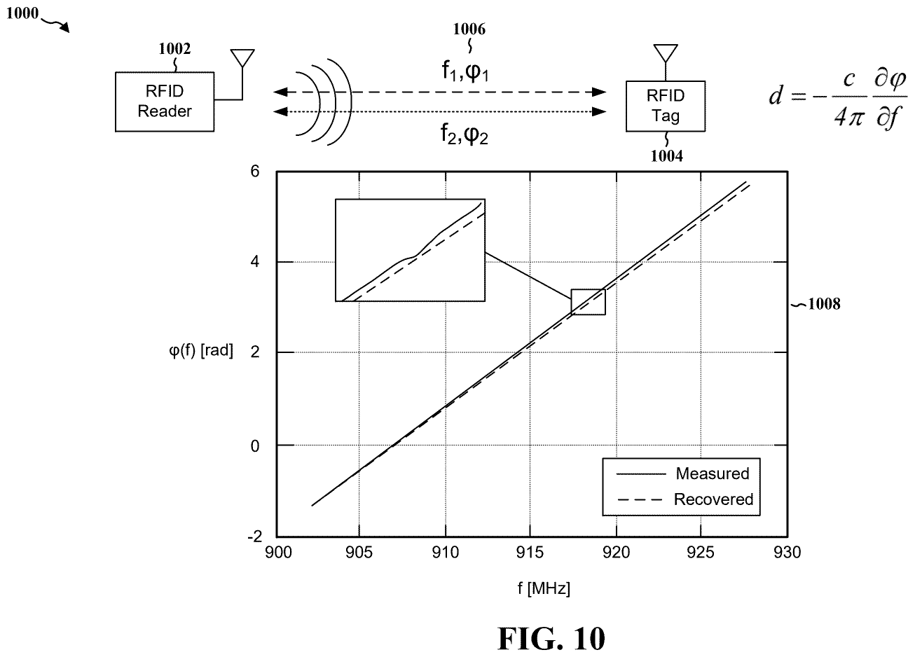

FIG. 10 is a diagram 1000 illustrating an example of estimating the distance between an RFID reader and an RFID tag based on frequency domain (FD)-PDOA in accordance with various aspects of the present disclosure. As shown at 1006, an RFID reader 1002 may transmit RF signals of different frequencies (e.g., f1, f2, etc.) to an RFID tag 1004. Then, the RFID reader 1002 may measure the phase (e.g., the phase angle in radians (rad)) of the backscattered RF signals in different frequencies and estimate a distance between the RFID reader 1002 and the RFID tag 1004 based on

$$d = - \frac{c}{4 π} \frac{Δφ}{Δ f} ,$$

such as shown at 1008 (e.g., showing measured and recovered phase information of received/backscattered signal).

In some examples, if the period between successive signals transmitted from an RFID reader is too short, a backscattered signal from an RFID tag may be received by the RFID reader after the RFID reader has transmitted another signal (e.g., after the RFID reader transmits a first signal and a second signal, the RFID reader receives a backscattered signal backscattered based on the first signal). This may cause the RFID reader unable to determine whether a backscattered signal received is associated with the just transmitted signal or the previously transmitted signal. This may be referred to as a range ambiguity where an RFID reader is unable to distinguish between backscattered signals, and the RFID reader may derive range information that is ambiguous (e.g., inaccurate or unreliable). In some examples, range ambiguity may occur when

$$d > {d}_{max} , where {d}_{max} = \frac{c}{2 Δ f} . Then , d = \frac{c Δ ϕ}{4 π Δ f} + \frac{c}{2 Δ f} k ,$$

where k is not known. For 30 KHz Δ_{f}, dₘₐₓ may be approximately 5000 meters (dₘₐₓ=5000 m), and for 640 KHz Δ_{f}, dₘₐₓ may be approximately 240 meters (dₘₐₓ=240 m), which may be sufficient for estimating a position/distance of a ZP-IoT device. As such, for certain subcarrier spacings (SCS) supported by a network (e.g., 5G-NR), the dₘₐₓ associated with these SCS may be large enough and suitable for ZP-IoT positioning. Aspects presented herein may enable a network entity to configure an RFID reader to estimate/determine the position or the distance of an RFID tag based on PDOA positioning. For example, when an RFID reader (e.g., a UE) is configured to locate/determine the position of an RFID tag and the RFID reader is also capable of communicate with a network entity (e.g., a base station), the RFID reader may send a positioning request to the network entity. Based on the positioning request, the network entity may configure one or more parameters associated with the PDOA positioning for the RFID reader, such as the frequency and/or time resources, the bandwidth, and/or the number of repetitions for the PDOA positioning.

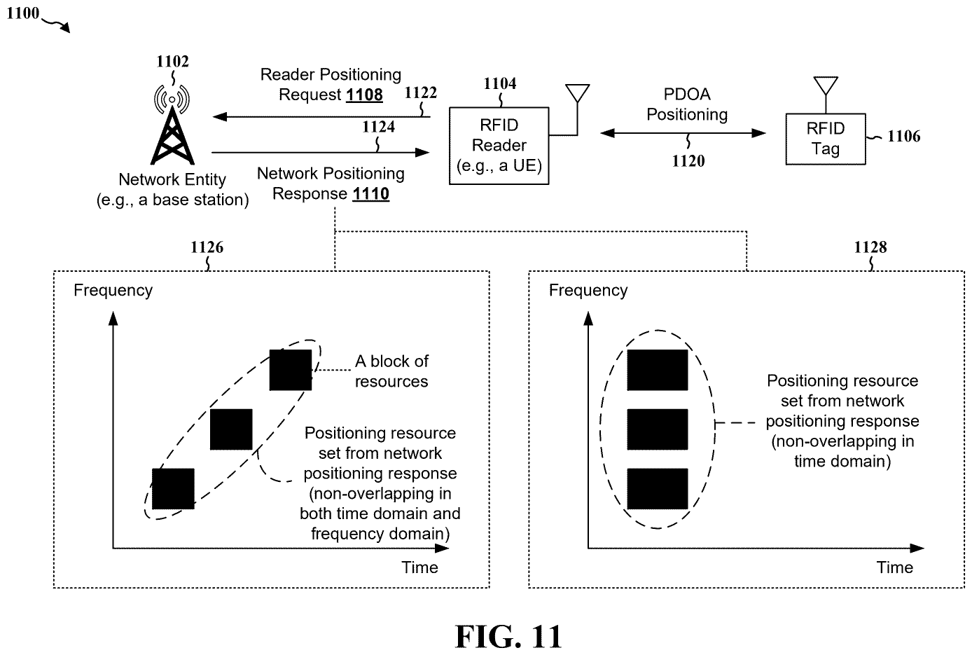

FIG. 11 is a diagram 1100 illustrating an example of a network entity configuring a set of resources associated with PDOA positioning for an RFID reader in accordance with various aspects of the present disclosure. In one example, as shown at 1120, an RFID reader 1104 (e.g., a UE) may be configured/triggered to determine the position of an RFID tag 1106 (or a distance between the RFID reader 1104 and the RFID tag 1106) based on PDOA positioning, such as based on frequency domain (FD)-phase difference of arrival (PDOA) (FD-PDOA) positioning.

Then, as shown at 1122, the RFID reader 1104 may transmit a reader positioning request 1108 to a network entity 1102 (e.g., a base station) to inform the network entity 1102 regarding performing the PDOA positioning for the RFID tag 1106. In response, as shown at 1124, the network entity 1102 may transmit a network positioning response 1110 to the RFID reader 1104, where the network positioning response 1110 may include one or more parameters/configurations associated with the PDOA positioning.

In one aspect of the present disclosure, the network positioning response 1110 may include resources in which the RFID reader 1104 may use for transmitting signals to the RFID tag 1106, such as described in connection with FIGS. 5 and 7 (e.g., energy/data signals for the RFID tag 1106 to backscatter). In one example, as shown at 1126, the resources may include a set of time and frequency domain resources that are non-overlapping in both time domain (TD) and frequency domain. In another example, as shown at 1128, the resources may include a set of time and frequency domain resources that are just non-overlapping in frequency domain. Then, based on the configurations/resources granted in the network positioning response 1110, the RFID reader 1104 may perform PDOA positioning/distance estimation of the RFID tag 1106 using these configurations/resources.

As the RFID reader 1104 is specified to compare different phases of backscattered signals from the RFID tag 1106 under PDOA positioning, the signals transmitted from the RFID reader 1104 (or the signals backscattered by the RFID tag 1106) may not overlap in frequency domain. In some scenarios, the signals transmitted from the RFID reader 1104 may also configured to be non-overlapping in time domain. For example, some RFID readers may be capable of transmitting just one block of resources (e.g., one energy signal) at one time (e.g., due to power limitation). Thus, the resources configured for these RFID readers may not overlap in time domain.

However, in some examples, it may be beneficial to configure an RFID reader to transmit one block of resources at one time (or to configure resources that are non-overlapping in time domain) as it may enlarge the transmission range/detection distance of the RFID reader. For example, if the RFID reader 1104 is configured to transmit one block of resources at a time, the RFID reader 1104 may use all available transmission power to transmit that one block of resources, which may result in a longer transmission distance/detection range. On the other hand, if the RFID reader 1104 is configured to transmit three blocks of resources at a time, such as shown at 1128, the RFID reader 1104 may be specified to distribute the available transmission power among the three blocks of resources, which may result in a shorter transmission distance/detection range compared to transmitting one block of resources at a time.

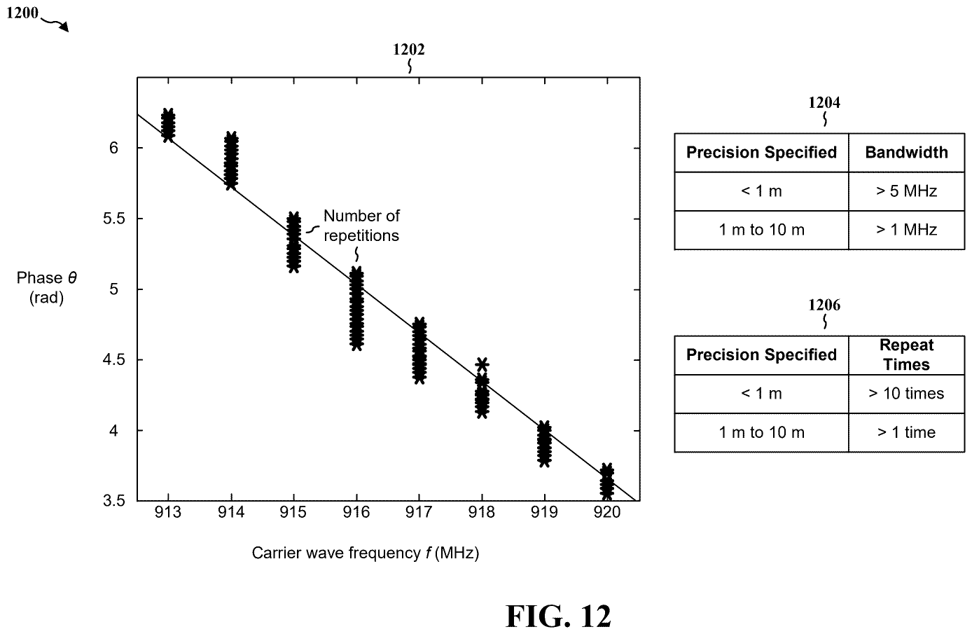

FIG. 12 is a diagram 1200 illustrating an example phase value distribution associated with FD-PDOA positioning of an RFID tag in accordance with various aspects of the present disclosure. In one example, an RFID tag (e.g., the RFID tag 1106) may be set to move from a first location to a second location and away from an RFID reader (e.g., the RFID reader 1104) using X number of steps. At each step, the RFID reader may use/transmit multiple transmission carrier wave frequencies (e.g., between frequencies 913 MHz to 920 MHz) to collect phase information from the RFID tag (e.g., approximately 200 RFID tag phase values are recorded corresponding to each frequency). The graph at 1202 shows an example phase distribution when carrier wave frequency changes from 913 MHz to 920 MHz at certain point between the first location and the second location. It may be observed that the phase value may linearly change with the carrier wave frequency.

Based on the diagram shown at 1202, it may be observed that the bandwidth used for positioning/localization of an RFID tag may influence the positioning/localization accuracy of the RFID tag. For example, if a frequency spacing of 1 MHz is used, using a total bandwidth of 20 MHz (e.g., using frequency range 910 MHz to 930 MHz) for PDOA positioning is likely to achieve a higher accuracy than using a total bandwidth of 5 MHz (e.g., using frequency range 910 MHz to 915 MHz). As such, in another aspect of the present disclosure, to improve or guarantee positioning accuracy, a bandwidth (BW) threshold or a BW-precision accuracy mapping may be defined/pre-configured at a network entity (and/or at an RFID reader). For example, as shown at 1204, when a precision (or the positioning precision/accuracy) is specified to be within one (1) meter for the positioning of an RFID tag, an RFID reader may be configured/specified to use at least five (5) MHz of bandwidth for the positioning, whereas when the precision is specified to be between one (1) to ten (10) meters, the RFID reader may be configured/specified to use at least one (1) MHz of bandwidth for the positioning.

Based on such mapping, if an RFID reader reports/requests a positioning/localization precision to a network entity (e.g., a base station) for an RFID tag positioning (e.g., using PDOA-based positioning, received signal strength indicator (RSSI)-based positioning, etc.), the network entity may determine how many BW is to be allocated for the RFID reader, which may be indicated to the RFID reader via the network positioning response. If the network entity is performing the positioning/localization of the RFID tag, the network entity may also use such mapping for determining the bandwidth used for the positioning. For example, referring back to FIG. 11, if the RFID reader 1104 is to determine the position/distance of the RFID tag 1106 within a precision of less than one meter, the RFID reader 1104 may indicate its positioning precision specification to the network entity 1102, such as via the reader positioning request 1108. In response (and based on the mapping/reconfiguration shown at 1204), the network entity 1102 may configure at least 5 MHz of bandwidth of resources for the RFID reader 1104 and/or indicate the RFID reader 1104 to use at least 5 MHz of bandwidth for performing the positioning of the RFID tag 1106, where the configuration/indication may be transmitted to the RFID reader 1104 via the network positioning response 1110. On the other hand, if the RFID reader 1104 is to determine the position/distance of the RFID tag 1106 within a positioning precision between one to ten meters, the network entity 1102 may configure 2 or 4 MHz of bandwidth of resources for the RFID reader 1104 and/or indicate the RFID reader 1104 to use 2 or 4 MHz of bandwidth for performing the positioning of the RFID tag 1106, where the configuration/indication may be transmitted to the RFID reader 1104 via the network positioning response 1110.

Referring back to FIG. 12, based on the diagram shown at 1202, it may also be observed that how many times the positioning is repeated for the positioning/localization of an RFID tag may influence the positioning/localization accuracy of the RFID tag. For example, if a specified positioning procedure is performed ten (10) times between an RFID reader and an RFID tag, the positioning/localization accuracy of the RFID tag is likely to be higher compared to performing the positioning procedure just one time. As such, in another aspect of the present disclosure, to improve or guarantee positioning accuracy, a repeat times threshold, or repeat times and precision accuracy mapping may be defined/pre-configured at a network entity (and/or at an RFID reader). For example, as shown at 1206, when a precision (or the positioning precision/accuracy) is specified to be within one (1) meter for the positioning of an RFID tag, an RFID reader may be configured to repeat the positioning for at least ten (10) times, whereas when the precision is specified to be between one (1) to ten (10) meters, the RFID reader may be configured to perform the positioning once.

Based on such mapping, if an RFID reader reports/requests a positioning/localization precision to a network entity (e.g., a base station) for a positioning (e.g., PDOA-based positioning, RSSI-based positioning, etc.), the network entity may determine how many repeat times is to be configured for the RFID reader, which may be indicated to or configured for the RFID reader via the network positioning response. If the network entity is performing the positioning/localization of the RFID tag, the network entity may also use such mapping for determining the repeat times for the positioning. For example, referring back to FIG. 11, if the RFID reader 1104 is to determine the position/distance of the RFID tag 1106 within a precision of less than one meter, the RFID reader 1104 may indicate its precision specification to the network entity 1102, such as via the reader positioning request 1108. In response (and based on the mapping/reconfiguration shown at 1206), the network entity 1102 may configure or indicate the RFID reader 1104 (e.g., via the network positioning response 1110) to perform the positioning (e.g., the PDOA-based positioning, the RSSI-based positioning, etc.) for at least ten (10) times. On the other hand, if the RFID reader 1104 is to determine the position/distance of the RFID tag 1106 within a precision between one to ten meters, the network entity 1102 may configure or indicate the RFID reader 1104 to perform the positioning just one time, at least one time, or no more than 10 times, etc.

As described in connection with FIG. 12, such precision/bandwidth/repeat times mapping (or table) may be defined/pre-configured at a network entity (e.g., a base station) and/or at an RFID reader (e.g., a UE). In one example, if such mapping/table is configured at the network entity and the network entity is responsible for conducting the positioning of an RFID tag, the network entity may determine the bandwidth used for the positioning and/or how many times the positioning is to be repeated based on the mapping/table. However, if the RFID reader is responsible for conducts positioning, the network entity may configure suitable bandwidth and/or repeat times to the RFID reader based on the mapping/table.

On the other hand, if such mapping/table is configured at the RFID reader, the RFID reader may determine the amount of bandwidth to be requested from the network entity (e.g., in the reader positioning request 1108) and/or how many times the reader positioning request is to be sent to the network entity. For example, the network entity 1102 may be configured to provide resources for the RFID reader 1104 to perform the positioning just one time for each reader positioning request 1108 received from the RFID reader 1104. As such, for the RFID reader 1104 to perform the positioning for ten (10) times (e.g., to achieve a precision of within one meter), the RFID reader 1104 may be specified to transmit ten reader positioning requests to the network entity 1102 and receive ten resources allocations/configurations from the network entity 1102 (e.g., via ten network positioning responses).

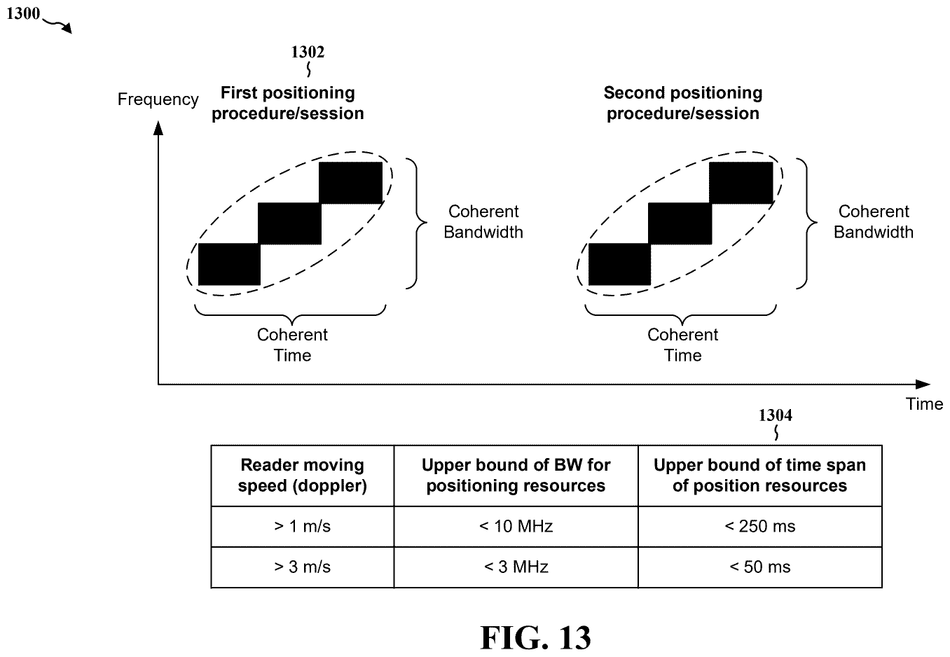

FIG. 13 is a diagram 1300 illustrating an example of coherent bandwidth and coherent time in accordance with various aspects of the present disclosure. For FD-PDOA-based positioning, another configuration factor to be considered may be the coherent channel BW and the coherent time, where resources used for the positioning (e.g., configured for the RFID reader) may not exceed the coherent channel BW and the coherent time. As shown at 1302, the coherence channel BW may refer to a statistical measurement of a range of frequencies over which a channel can be considered flat, or in other words the approximate maximum bandwidth or frequency interval over which two frequencies of a signal are likely to experience comparable or correlated amplitude fading. On the other hand, coherence time may refer to a time duration over which a channel impulse response is considered to be not varying. Such channel variation may be more significant in wireless communications systems, due to Doppler effects.

As such, in another aspect of the present disclosure, a network entity (e.g., the network entity 1102, a base station, etc.) may determine the bandwidth and time span of the time and frequency resources used for FD-PDOA positioning for an RFID reader (e.g., the RFID reader 1104, a UE, etc.) based on the moving speed (or Doppler) of the RFID reader (e.g., if the RFID reader is not stationary). For example, resources configured for the RFID reader (e.g., via the network positioning response from the network entity) may be specified to be within the coherent channel BW and the coherent time. Similarly, as shown at 1304, a mapping/table may be defined/pre-configured at the network entity and/or at the RFID reader. For example, when the RFID reader is moving at a speed greater than one meter per second (1 m/s) but below three meters per second (3 m/s), the network entity may configure a set of time and frequency resources (e.g., via the network positioning response) that does not exceed 10 MHz in bandwidth and 250 milliseconds (ms) in time span. On the other hand, if the RFID reader is moving at a speed greater than three meters per second (3 m/s), the network entity may configure a set of time and frequency resources (e.g., via the network positioning response) that does not exceed 3 MHz in bandwidth and 50 milliseconds (ms) in time span, etc.

When an RFID reader (e.g., a UE) is configured/triggered to determine a distance between the RFID reader and an RFID tag (e.g., 100 meters away) or a position of the RFID tag (e.g., x, y, z location, longitude and latitude coordinates, etc.), the RFID reader may request a network entity (e.g., a base station, a location server, an LMF, etc.) to perform the positioning (which may be referred to as U E-assisted positioning in some examples) or the RFID reader may perform the positioning itself (which may be referred to as UE-based positioning in some examples). If the network entity is aware of whether the RFID reader is to determine the distance or the position of the RFID tag and/or whether the RFID reader is to perform the positioning itself (e.g., based on the reader positioning request received from the RFID reader), the network entity may provide corresponding response/configuration to the RFID reader, such as via the network positioning response.

For example, referring back to FIG. 11, the RFID reader 1104 may provide PDOA measurements for the RFID tag 1106 to the network entity 1102 and request the network entity 1102 to determine the position/distance of the RFID tag 1106 (e.g., via the reader positioning request 1108). In response, the network entity may calculate/estimate the position/distance of the RFID tag 1106 based on the PDOA measurements from the RFID reader (and also from other RFID readers if multiple RFID readers are involved with the positioning of the RFID tag 1106), and the network entity may feedback the determined/estimated position/distance of the RFID tag 1106 to the RFID reader 1104 (e.g., via the reader positioning response 1110). Then, the positioning request from the RFID reader 1104 may be terminated. However, in some scenarios, if the RFID reader is configured to determine the position/distance of the RFID tag 1106 itself, additional signaling and configuration(s) may be specified between the network entity 1102 and the RFID reader 1104. For example, as described in connection with FIG. 11, if the RFID reader 1104 is configured to determine the position of the RFID tag 1106, the RFID reader may request a set of time and frequency resources for performing the positioning (e.g., via the reader positioning request 1108). In response, the network entity 1102 may allocate a set of time and frequency resources for the RFID reader 1104 to perform the positioning (e.g., via the network positioning response 1110). In another example, as described in connection with FIG. 12, if the RFID reader 1104 is specified to determine the position of the RFID tag 1106 with certain accuracy, the RFID reader 1104 may be configured to repeatedly perform the positioning for multiple times, where the network entity 1102 may provide a target repeat times to the RFID reader 1104 (e.g., via the network positioning response 1110).

In some scenarios, different positioning precisions may specify different positioning methods, and different positioning methods may specify different resources. For example, received signal strength (RSS)-based or received signal strength indicator (RSSI)-based positioning method may specify a one-shot resource in time domain, whereas FD-PDOA based positioning method may specify certain bandwidth resources for positioning, such as described in connection with FIG. 11.

Aspects presented herein may improve the positioning efficiency and accuracy of an RFID tag performed by an RFID reader. In one aspect, the RFID reader may indicate to a network entity at least one positioning method it is configured to use (e.g., RSSI-based positioning, PDOA-based positioning, TDOA-based positioning, etc.), such as via a reader positioning request. In response, the network entity may provide suitable configuration(s), such as resource allocations, for the RFID reader based on the indicated positioning method(s) (e.g., via a network positioning response). In another aspect, as different positioning methods may specify different positioning precisions, an RFID reader may also report/indicate its positioning precision demand to a network entity, rather than explicitly indicating different positioning methods to the network entity (e.g., via a reader positioning request). In response, the network entity may provide suitable configuration(s) for the RFID reader (e.g., via a network positioning response) based on the positioning precision demand. In some examples, besides RFID reader deciding the positioning method(s), the network entity may also be configured to determine at least one positioning method for the RFID reader, such as via an L1/L2/L3 signaling or the network positioning response.

In one aspect of the present disclosure, when an RFID reader (e.g., the RFID reader 1104 is configured to determine just a distance between the RFID reader and an RFID tag (e.g., the RFID tag 1106), the RFID reader may transmit just one reader positioning request to a network entity (e.g., the network entity 1102), and receive one network positioning response from the network entity that includes one or more configurations (e.g., resource allocation, positioning parameter(s), etc.) associated with the determination of the distance. On the other hand, if an RFID reader is configured to determine a location of an RFID tag (e.g., its x, y, z location, longitude and latitude coordinates, etc.), the RFID reader may be configured to transmit multiple reader positioning requests to a network entity, where the reader positioning requests may not overlap in time domain. As such, an association or a relationship may be defined/configured between reader positioning request(s) and network positioning response(s). For example, a set of reader positioning requests and a set of network positioning response(s) may be associated with each other based on timing (or a timing window), based on an identification (ID) associated with the RFID tag(s), based on an ID associated with a reader positioning request (which may be referred to as a “request ID” hereafter), and/or based on an ID associated with a network positioning response (which may be referred to as a “response ID” hereafter), etc. Such associated may improve the RFID tag positioning, such as when an RFID reader is configured to locate multipole RFID tags.

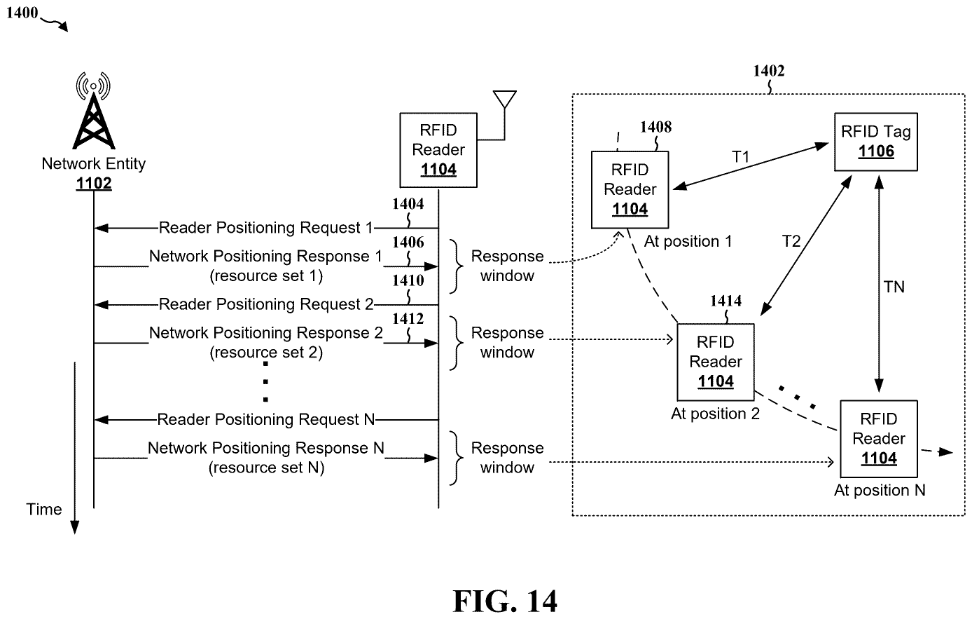

FIG. 14 is a diagram 1400 illustrating an example of an RFID reader determining a location of an RFID tag in accordance with various aspects of the present disclosure. In one example, as shown at 1402, an RFID reader 1104 may be configured to determine the location of an RFID tag 1106 (e.g., its x, y, z location, longitude and latitude coordinates, etc.) based on measuring distances between the RFID reader 1104 and the RFID tag 1106 at multiple positions (e.g., similar to performing a trilateration via multiple RFID readers). As such, the RFID reader 1104 may be specified to transmit multiple reader positioning requests to a network entity 1102. For example, at 1404, the RFID reader 1104 may transmit a first reader positioning request to the network entity 1102, where the first reader positioning request may indicate that the RFID reader 1104 is to determine the distance between the RFID reader 1104 and the RFID tag 1106. In some examples, the reader positioning request may include one or more positioning methods in which the RFID reader 1104 is capable of performing, such as ToA-based positioning, TDOA-based positioning, RSS-based positioning, PDOA-based positioning, and/or AoA-based positioning, etc. In response, at 1406, the network entity 1102 may provide suitable configuration(s), via a first network positioning response, for the RFID reader 1104 to perform the specified positioning (e.g., the distance estimation), such as a specified positioning method, the time and/or frequency resources for transmitting the signals, password keys for communicating with the RFID tag 1106 (if the RFID tag 1106 is password protected/encrypted), and/or waveforms to be used, etc. Then, as shown at 1408, based on the configuration(s)/first network positioning response, the RFID reader 1104 may perform a first distance estimation between the RFID reader 1104 and the RFID tag 1106 at a first point in time (T1) or at a first position (position 1).

After that, at 1410, the RFID reader 1104 may transmit a second reader positioning request to the network entity 1102, where the second reader positioning request may also indicate that the RFID reader 1104 is to determine the distance between the RFID reader 1104 and the RFID tag 1106 based on a specified positioning method. In response, at 1406, the network entity 1102 may provide suitable configuration(s), via a second network positioning response, for the RFID reader 1104 to perform the specified positioning. Similarly, as shown at 1414, based on the configuration(s)/second network positioning response, the RFID reader 1104 may perform a second distance estimation between the RFID reader 1104 and the RFID tag 1106 at a second point in time (T2) or at a second position (position 2). The RFID reader 1104 may continue and repeat this process until it has sufficient positioning measurements to determine the position of the RFID tag 1106 (e.g., up to N^{th} position).

In some scenarios, the periodicity in which the RFID reader 1104 requests the network entity 1102 for positioning configurations (or the periodicity in which the reader transmits the reader positioning requests) may also affect the positioning accuracy and/or the resource use efficiency, such as when the RFID reader 1104 is moving at different speeds.

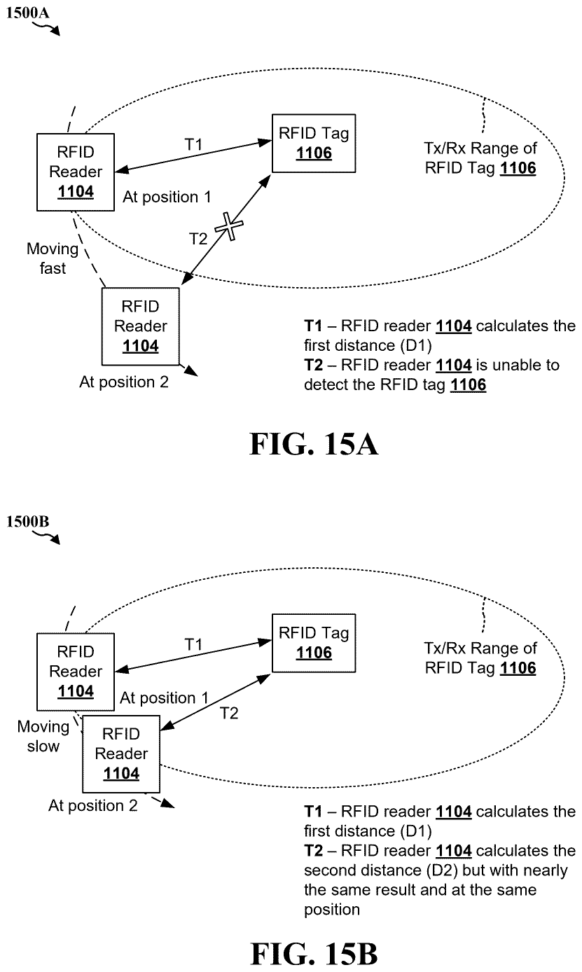

FIG. 15A is a diagram 1500A illustrating an example of a fast-moving RFID reader in accordance with various aspects of the present disclosure. When the RFID reader 1104 is moving fast (e.g., 10 m/s) but the periodicity in which the reader transmits the reader positioning requests is low (e.g., one reader positioning request per every 10 seconds), the RFID reader 1104 may go out of RFID tag's detectable (e.g., transmission/reception (Tx/Rx)) range quickly. For example, after the RFID reader 1104 measures the distance between the RFID reader 1104 and the RFID tag 1106 at a first position (position 1), the RFID reader 1104 at a second position (position 2) may be 100 meters away from the first position (and may be out of the Tx/Rx range of the RFID tag 1106).

FIG. 15B is a diagram 1500B illustrating an example of a slow-moving RFID reader in accordance with various aspects of the present disclosure. Conversely, when the RFID reader 1104 is moving slow (e.g., 0.1 m/s) but the periodicity in which the reader transmits the reader positioning requests is high (e.g., one reader positioning request per every 0.1 seconds), the RFID reader 1104 may repeatedly detect the same result. For example, after the RFID reader 1104 measures the distance between the RFID reader 1104 and the RFID tag 1106 at a first position (position 1), the RFID reader 1104 at a second position (position 2) may be just 0.01 meters away from the first position. Thus, the distances measured by the RFID reader 1104 at the first position and the second position may be identical, which may not be useful for positioning of the RFID tag 1106 and may cause additional power and resources to be wasted.

In another aspect of the present disclosure, a mapping/table may be defined/pre-configured at a network entity (and/or at an RFID reader). If the mapping/table is defined/pre-configured at the network entity, the network entity may dynamically indicate/configure the mapping for the RFID reader (e.g., via the L1/L2/L3 signaling, the network positioning response 1110, etc.), such as based on information in the reader positioning request (e.g., the reader positioning request 1108).

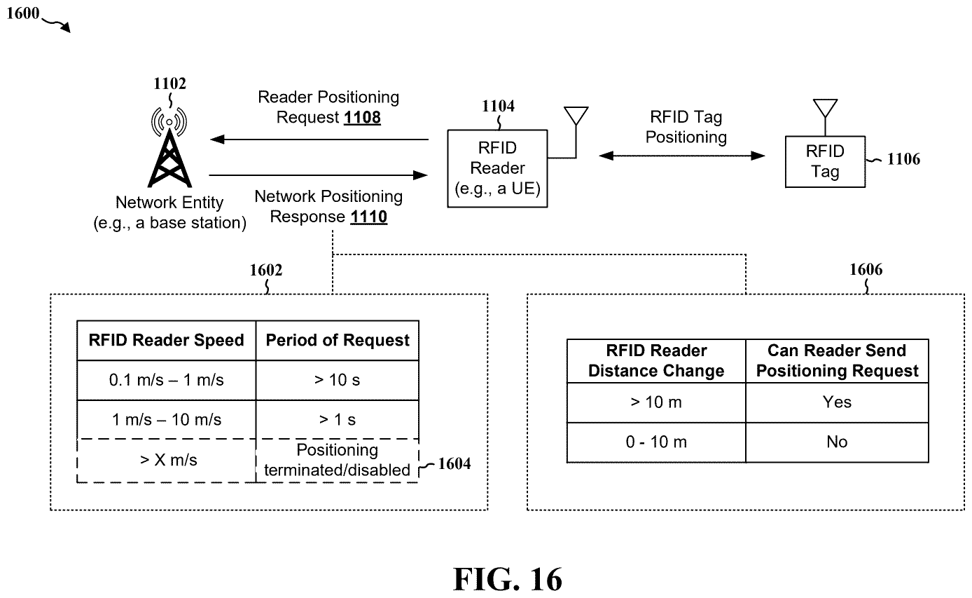

As shown by a diagram 1600 of FIG. 16, a mapping/association between the RFID reader speed and period of request may be defined/pre-configured at the network entity 1102. For example, as shown at 1602, the mapping/association may indicate that when an RFID reader is moving between 0.1 meter per second (m/s) and 1 m/s, the RFID reader may transmit the reader positioning request 1108 at a periodicity greater than 10 seconds (e.g., the RFID reader is configured to transmit two consecutive reader positioning requests that are at least 10 seconds apart). On the other hand, when an RFID reader is moving between 1 m/s and 10 m/s, the RFID reader may transmit the reader positioning request 1108 at a periodicity greater than 1 second (e.g., the RFID reader may two consecutive reader positioning requests that are at least 1 second apart). Thus, when the network entity 1102 is able to determine the speed of the RFID reader 1104, such as based on its own detection or via a reporting from the RFID reader (e.g., via the reader positioning request 1108), the network entity 1102 may dynamically indicate the periodicity for transmitting the reader positioning request to the RFID reader 1104. In another example, as shown at 1604, an RFID reader speed threshold (X m/s) may also be defined/pre-configured at the network entity 1102 and/or at the RFID reader 1104. If the speed of the RFID reader 1104 exceeds this speed threshold, the RFID reader may be refrained from performing the positioning or the distance estimation.

In another example, a mapping/association between an RFID reader's distance change and whether the RFID reader may continue to perform positioning or distance estimation of an RFID tag may be defined/pre-configured at the network entity 1102 and/or at the RFID reader 1104. For example, as shown at 1606, the mapping/association may indicate that when the change in an RFID reader's distance exceeds 10 meters (e.g., between two consecutive reader positioning requests, within a specified time duration, etc.), the RFID reader may transmit (or continue to transmit) another reader positioning request. On the other hand, when the change in an RFID reader's distance does not exceed 10 meters (e.g., the change is between 0 to 10 meters), the RFID reader may be refrained from transmitting another reader positioning request. Thus, when the network entity 1102 is able to determine the distance change of the RFID reader 1104, such as based on its own detection or via a reporting from the RFID reader (e.g., via the reader positioning request 1108), the network entity 1102 may dynamically indicate to the RFID reader 1104 whether the RFID reader 1104 may transmit another reader positioning request. In other words, a new reader positioning request to the network entity 1102 may be trigged at the RFID reader 1104 the position change of the RFID reader 1104 is larger than the distance threshold.

As described in connection with FIG. 16, while an RFID reader (e.g., the RFID reader 1104) may be configured to determine whether it is able to send reader positioning request and/or the periodicity for sending reader positioning requests (e.g., if the mapping/table is defined/pre-configured at the RFID reader), a network entity (e.g., the network entity 1102) may also make such determination for the RFID reader based on information provided by the RFID reader (e.g., via an RFID reader report, a reader positioning request, etc.). For example, as shown by FIG. 16, the RFID reader 1104 may include or report its speed (or Doppler) and/or its position change to the network entity 1102, such as via the reader positioning request 1108. In response, based on the mapping/table shown at 1602 and 1606, the network entity 1102 may determine whether to respond to the reader positioning request 1108 (e.g., the RFID reader 1104 may be configured not to perform positioning/distance estimation without a network positioning response), or the network entity 1102 may determine the periodicity of resources (granted to the RFID reader 1104), such as via the network positioning response 1110, etc.

Table 2 below shows examples of information that may be included in a reader positioning request and a network positioning response based on aspects presented herein.

TABLE 2
Example Information Provided in Reader Positioning
Request and Network Positioning Response

| Reader Positioning Request | Network Positioning Response |
|---|---|
| Request ID | Response ID |
| Distance or location (x, y, z) to be | Positioning resources (resource |
| determined for an RFID tag | sets) |
| Indication of whether the network | Positioning method |
| entity or the RFID reader conducts | |
| the positioning | |
| Positioning method(s) | Repeat times |
| Positioning precision demand | Bandwidth |
| RFID reader moving speed or | |
| Doppler | |
| RFID reader positioning change | |
| (e.g., amount of distance changed, or | |
| an indication of whether the distance | |
| change exceeds a threshold, etc.) | |

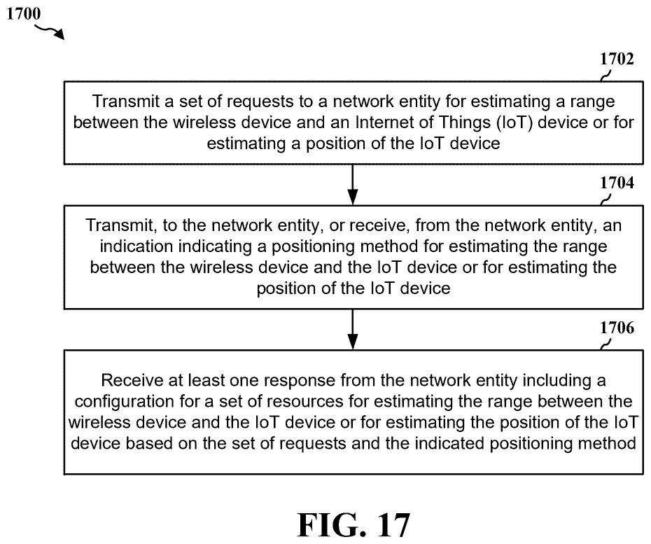

FIG. 17 is a flowchart 1700 of a method of wireless communication. In some scenarios, the method may be performed by a wireless device (e.g., the UE 104, 404; the RFID reader 504, 1002, 1104; the apparatus 1804). In one aspect, the method may enable the wireless device (e.g., an RFID reader, a UE, etc.) to estimate/determine the position or the distance of an RFID tag based on phase difference of arrival (PDOA) positioning. In another aspect, the method may enable the wireless device to communicate with a network entity for receiving configurations associated with positioning of an RFID tag.

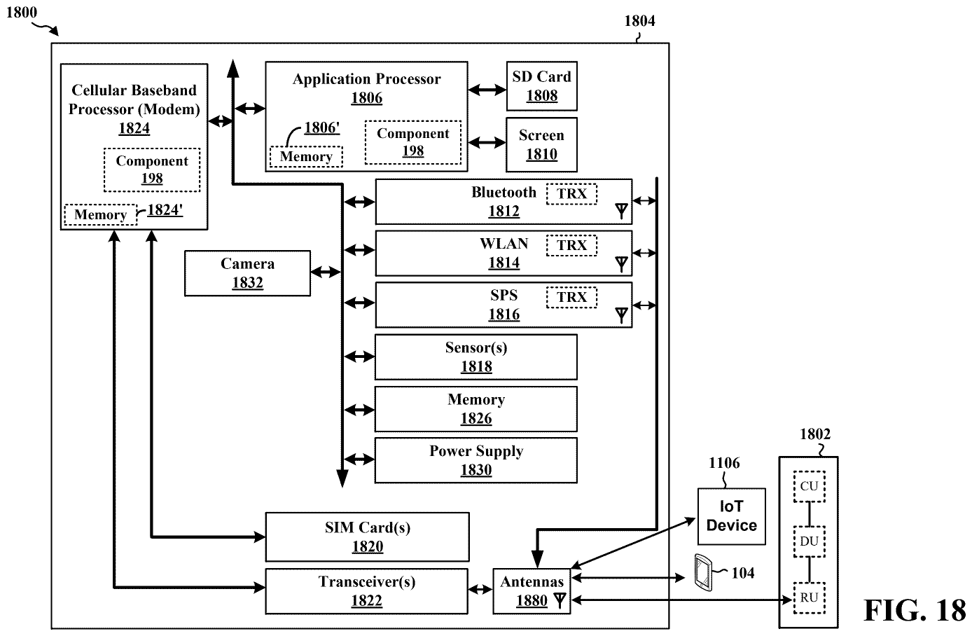

At 1702, the wireless device may transmit a set of requests to a network entity for estimating a range between the wireless device and an IoT device or for estimating a position of the IoT device, such as described in connection with FIGS. 11, 14, and 16. For example, as shown at 1404 and 1410 of FIG. 14, the RFID reader 1104 may transmit a set of reader positioning requests to the network entity 1102 for estimating distances between the RFID reader 1104 and the RFID tag 1106 and determining the position of the RFID tag 1106. The transmission of the set of requests may be performed by, e.g., the IoT device positioning component 198, the cellular baseband processor 1824 and/or the transceiver(s) 1822 of the apparatus 1804 in FIG. 18.

At 1704, the wireless device may transmit or receive an indication indicating a positioning method for estimating the range between the wireless device and the IoT device or for estimating the position of the IoT device, where the indication is transmitted to or received from the network entity, such as described in connection with FIGS. 11, 14, and 16. For example, at 1404 or 1406 of FIG. 14, the RFID reader 1104 may transmit or receive an indication from the network entity 1102 indicating a positioning method for estimating the range between the RFID reader 1104 and the RFID tag 1106 or for estimating the position of the RFID tag 1106. The transmission or reception of the indication may be performed by, e.g., the IoT device positioning component 198, the cellular baseband processor 1824 and/or the transceiver(s) 1822 of the apparatus 1804 in FIG. 18.

At 1706, the wireless device may receive at least one response from the network entity including a configuration for a set of resources for estimating the range between the wireless device and the IoT device or for estimating the position of the IoT device based on the set of requests and the indicated positioning method, such as described in connection with FIGS. 11, 14, and 16. For example, as shown at 1406 and 1412 of FIG. 14, the RFID reader 1104 may receive a set of network positioning responses from the network entity 1102, where the set of network positioning responses may include a configuration for a set of resources for estimating the range between the RFID reader 1104 and the RFID tag 1106 or for estimating the position of the RFID tag 1106. The reception of the at least one response may be performed by, e.g., the IoT device positioning component 198, the cellular baseband processor 1824 and/or the transceiver(s) 1822 of the apparatus 1804 in FIG. 18.

In one example, the wireless device may estimate the range between the wireless device and the IoT device or estimate the position of the IoT device using the indicated positioning method via the set of resources.

In another example, the wireless device may transmit a precision specified for estimating the range between the wireless device and the IoT device or for estimating the position of the IoT device to the network entity, and the wireless device may receive the indication indicating the positioning method from the network entity based on the precision specified.

In another example, the set of requests may correspond to one request for estimating the range between the wireless device and the IoT device, and the set of requests may correspond to more than one request for estimating the position of the IoT device, the set of requests being non-overlapping in time domain.

In another example, each of the set of requests may be associated with the at least one response based on a timing window, an ID associated with the IoT device, a request ID associated with each of the set of requests, a response ID associated with the at least one response, or a combination thereof.

In another example, a number of requests in the set of requests or a periodicity between requests in the set of requests may be based on a moving speed of the wireless device. In such an example, the wireless device may determine the periodicity based on the moving speed of the wireless device, or the wireless device may receive the periodicity from the network entity based on the moving speed of the wireless device. In such an example, the wireless device may refrain from estimating the range between the wireless device and the IoT device or estimating the position of the IoT device to the network entity if the moving speed of the wireless device exceeds a speed threshold.

In another example, the wireless device may transmit a second set of requests to the network entity for estimating the range between the wireless device and the IoT device or for estimating the position of the IoT device if a position of the wireless device has changed its position for more than a distance threshold.

In another example, the wireless device may transmit a second indication of a moving speed or a position change of the wireless device to the network entity, where the configuration for the set of resources may include a periodicity associated with the set of resources that is based on the moving speed or the position change.

In another example, the positioning method may include: ToA-based positioning, TDOA-based positioning, RSS-based positioning, PDOA-based positioning, or AoA-based positioning.

In another example, the positioning method may correspond to FD-PDOA positioning, and the set of resources may be non-overlapping in FD. In such an example, the wireless device may estimate the range between the wireless device and the IoT device based on FD-PDOA positioning using the set of resources. In one example, to estimate the range between the wireless device and the IoT device based on FD-PDOA positioning, the wireless device may transmit a first set of signals to the IoT device, receive a second set of signals backscattered from the IoT device, and measure PDOA of the second set of signals. In another example, the wireless device may estimate the position of the IoT device based on the estimated range, or transmit the estimated range to the network entity to assist the network entity in estimating the position of the IoT device. In another example, the set of resources may be further non-overlapping in time domain (TD). In another example, the configuration may further include a bandwidth or a minimum bandwidth for the set of resources, and the bandwidth or the minimum bandwidth may be based on a precision specified for estimating the range between the wireless device and the IoT device. In another example, the configuration further may include a number of times or a minimum number of times for which the PDOA positioning is to be performed by the wireless device, and the number of times or the minimum number of times may be based on a precision specified for estimating the range between the wireless device and the IoT device. In another example, the configuration may further include a minimum bandwidth and a minimum time span for the set of resources, and the minimum bandwidth and the minimum time span may be based on a moving speed of the wireless device for maintaining a coherent bandwidth and a coherent time for the PDOA positioning.

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include a cellular baseband processor 1824 (also referred to as a modem) coupled to one or more transceivers 1822 (e.g., cellular RF transceiver). The cellular baseband processor 1824 may include on-chip memory 1824′. In some aspects, the apparatus 1804 may further include one or more subscriber identity modules (SIM) cards 1820 and an application processor 1806 coupled to a secure digital (SD) card 1808 and a screen 1810. The application processor 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial measurement unit (IM U), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize the antennas 1880 for communication. The cellular baseband processor 1824 communicates through the transceiver(s) 1822 via one or more antennas 1880 with the UE 104 and/or with an RU associated with a network entity 1802. The cellular baseband processor 1824 and the application processor 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor 1824 and the application processor 1806 are each responsible for general processing, including the execution of software stored on the computer-readable medium/memory. The software, when executed by the cellular baseband processor 1824/application processor 1806, causes the cellular baseband processor 1824/application processor 1806 to perform the various functions described supra. The computer-readable medium/memory may also be used for storing data that is manipulated by the cellular baseband processor 1824/application processor 1806 when executing software. The cellular baseband processor 1824/application processor 1806 may be a component of the UE 350 and may include the memory 360 and/or at least one of the TX processor 368, the RX processor 356, and the controller/processor 359. In one configuration, the apparatus 1804 may be a processor chip (modem and/or application) and include just the cellular baseband processor 1824 and/or the application processor 1806, and in another configuration, the apparatus 1804 may be the entire UE (e.g., see 350 of FIG. 3) and include the additional modules of the apparatus 1804.

As discussed supra, the IoT device positioning component 198 is configured to transmit a set of requests to a network entity for estimating a range between the wireless device and an IoT device or for estimating a position of the IoT device. The IoT device positioning component 198 may also be configured to transmit or receive an indication indicating a positioning method for estimating the range between the wireless device and the IoT device or for estimating the position of the IoT device, where the indication is transmitted to or received from the network entity. The IoT device positioning component 198 may also be configured to receive at least one response from the network entity including a configuration for a set of resources for estimating the range between the wireless device and the IoT device or for estimating the position of the IoT device based on the set of requests and the indicated positioning method. The IoT device positioning component 198 may be within the cellular baseband processor 1824, the application processor 1806, or both the cellular baseband processor 1824 and the application processor 1806. The IoT device positioning component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1804 may include a variety of components configured for various functions. In one configuration, the apparatus 1804 (in particular the cellular baseband processor 1824 and/or the application processor 1806), includes means for transmitting a set of requests to a network entity for estimating a range between the wireless device and an IoT device or for estimating a position of the IoT device. The apparatus 1804 may further include means for transmitting or means for receiving an indication indicating a positioning method for estimating the range between the wireless device and the IoT device or for estimating the position of the IoT device, where the indication is transmitted to or received from the network entity. The apparatus 1804 may further include means for receiving at least one response from the network entity including a configuration for a set of resources for estimating the range between the wireless device and the IoT device or for estimating the position of the IoT device based on the set of requests and the indicated positioning method.

In one example, the apparatus 1804 may further include means for estimating the range between the wireless device and the IoT device or means for estimating the position of the IoT device using the indicated positioning method via the set of resources.

In another example, the apparatus 1804 may further include means for transmitting a precision specified for estimating the range between the wireless device and the IoT device or for estimating the position of the IoT device to the network entity, and means for receiving the indication indicating the positioning method from the network entity based on the precision specified.

In another example, the set of requests may correspond to one request for estimating the range between the wireless device and the IoT device, and the set of requests may correspond to more than one request for estimating the position of the IoT device, the set of requests being non-overlapping in time domain.

In another example, each of the set of requests may be associated with the at least one response based on a timing window, an ID associated with the IoT device, a request ID associated with each of the set of requests, a response ID associated with the at least one response, or a combination thereof.

In another example, a number of requests in the set of requests or a periodicity between requests in the set of requests may be based on a moving speed of the wireless device. In such an example, the apparatus 1804 may further include means for determining the periodicity based on the moving speed of the wireless device, or means for receiving the periodicity from the network entity based on the moving speed of the wireless device. In such an example, the apparatus 1804 may further include means for refraining from estimating the range between the wireless device and the IoT device or estimating the position of the IoT device to the network entity if the moving speed of the wireless device exceeds a speed threshold.

In another example, the apparatus 1804 may further include means for transmitting a second set of requests to the network entity for estimating the range between the wireless device and the IoT device or for estimating the position of the IoT device if a position of the wireless device has changed its position for more than a distance threshold.

In another example, the apparatus 1804 may further include means for transmitting a second indication of a moving speed or a position change of the wireless device to the network entity, where the configuration for the set of resources may include a periodicity associated with the set of resources that is based on the moving speed or the position change.

In another example, the positioning method may include: ToA-based positioning, TDOA-based positioning, RSS-based positioning, PDOA-based positioning, or AoA-based positioning.

In another example, the positioning method may correspond to FD-PDOA positioning, and the set of resources may be non-overlapping in FD. In such an example, the apparatus 1804 may further include means for estimating the range between the wireless device and the IoT device based on FD-PDOA positioning using the set of resources.

In one example, to estimate the range between the wireless device and the IoT device based on FD-PDOA positioning, the apparatus 1804 is configured to transmit a first set of signals to the IoT device, receive a second set of signals backscattered from the IoT device, and measure PDOA of the second set of signals.

In another example, the apparatus 1804 may further include means for estimating the position of the IoT device based on the estimated range, or means for transmitting the estimated range to the network entity to assist the network entity in estimating the position of the IoT device.

In another example, the set of resources may be further non-overlapping in time domain.

In another example, the configuration may further include a bandwidth or a minimum bandwidth for the set of resources, and the bandwidth or the minimum bandwidth may be based on a precision specified for estimating the range between the wireless device and the IoT device.

In another example, the configuration further may include a number of times or a minimum number of times for which the PDOA positioning is to be performed by the wireless device, and the number of times or the minimum number of times may be based on a precision specified for estimating the range between the wireless device and the IoT device.

In another example, the configuration may further include a minimum bandwidth and a minimum time span for the set of resources, and the minimum bandwidth and the minimum time span may be based on a moving speed of the wireless device for maintaining a coherent bandwidth and a coherent time for the PDOA positioning.

The means may be the IoT device positioning component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

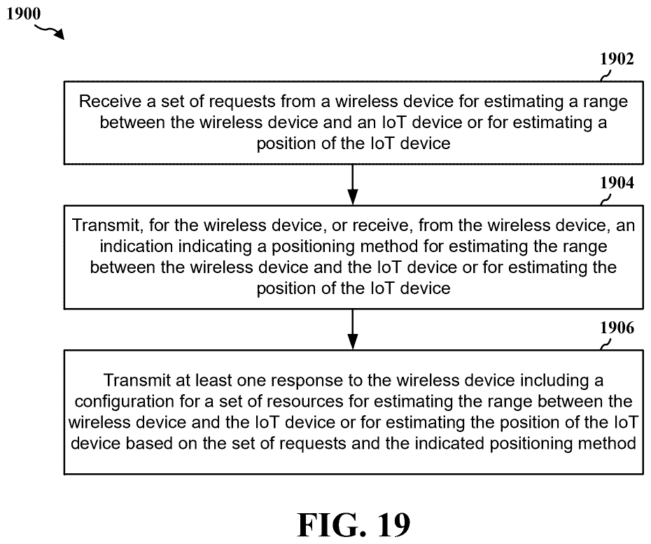

FIG. 19 is a flowchart 1900 of a method of wireless communication. In some scenarios, the method may be performed by a network entity (e.g., the base station 102; the network entity 1102, 2002). In one aspect, the method may enable the network entity to configure a wireless device (e.g., an RFID reader, a UE, etc.) to estimate/determine the position or the distance of an RFID tag based on phase difference of arrival (PDOA) positioning. In another aspect, the method may enable the network entity to communicate with a wireless device and configure the wireless device with parameters associated with positioning of an RFID tag.

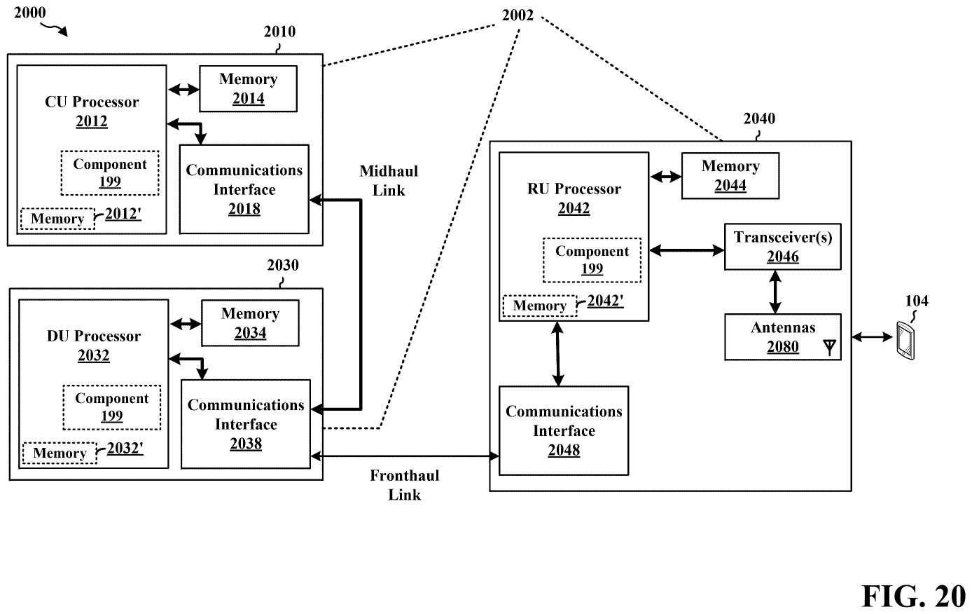

At 1902, the network entity may receive a set of requests from a wireless device for estimating a range between the wireless device and an IoT device or for estimating a position of the IoT device, such as described in connection with FIGS. 11, 14, and 16. For example, as shown at 1404 and 1410 of FIG. 14, the network entity 1102 may receive a set of reader positioning requests from the RFID reader 1104 for estimating distances between the RFID reader 1104 and the RFID tag 1106 and determining the position of the RFID tag 1106. The reception of the set of requests may be performed by, e.g., the IoT device positioning configuration component 199, the RU processor 2042 and/or the transceiver(s) 2046 of the network entity 2002 in FIG. 20. At 1904, the network entity may transmit or receive an indication indicating a positioning method for estimating the range between the wireless device and the IoT device or for estimating the position of the IoT device, where the indication is transmitted to or received from the wireless device, such as described in connection with FIGS. 11, 14, and 16. For example, at 1404 or 1406 of FIG. 14, the network entity 1102 may transmit or receive an indication from the RFID reader 1104 indicating a positioning method for estimating the range between the RFID reader 1104 and the RFID tag 1106 or for estimating the position of the RFID tag 1106. The transmission or reception of the indication may be performed by, e.g., the IoT device positioning configuration component 199, the RU processor 2042 and/or the transceiver(s) 2046 of the network entity 2002 in FIG. 20.

At 1906, the network entity may transmit at least one response to the wireless device including a configuration for a set of resources for estimating the range between the wireless device and the IoT device or for estimating the position of the IoT device based on the set of requests and the indicated positioning method, such as described in connection with FIGS. 11, 14, and 16. For example, as shown at 1406 and 1412 of FIG. 14, the network entity 1102 may transmit a set of network positioning responses to the RFID reader 1104, where the set of network positioning responses may include a configuration for a set of resources for estimating the range between the RFID reader 1104 and the RFID tag 1106 or for estimating the position of the RFID tag 1106. The transmission of the at least one response may be performed by, e.g., the IoT device positioning configuration component 199, the RU processor 2042 and/or the transceiver(s) 2046 of the network entity 2002 in FIG. 20.

In one example, the network entity may receive a precision specified for estimating the range between the wireless device and the IoT device or for estimating the position of the IoT device from the wireless device, and the network entity may transmit the indication indicating the positioning method to the wireless device based on the precision specified.

In another example, each of the set of requests may be associated with the at least one response based on a timing window, an ID associated with the IoT device, a request ID associated with each of the set of requests, a response ID associated with the at least one response, or a combination thereof.

In another example, a number of requests in the set of requests or a periodicity between requests in the set of requests may be based on a moving speed of the wireless device. In such an example, the network entity may determine the periodicity based on the moving speed of the wireless device, and the network entity may transmit the determined periodicity to the wireless device.

In another example, the network entity may receive a second indication of a moving speed or a position change of the wireless device from the wireless device, where the configuration for the set of resources may include a periodicity associated with the set of resources that is based on the moving speed or the position change.

In another example, the positioning method may include: ToA-based positioning, TDOA-based positioning, RSS-based positioning, PDOA-based positioning, or AoA-based positioning.

In another example, the positioning method may correspond to FD-PDOA positioning, and where the set of resources is non-overlapping in FD. In such an example, the network entity may receive an estimated range between the wireless device and the IoT device from the wireless device, and the network entity may estimate the position of the IoT device based on the estimated range. In such an example, the set of resources may be further non-overlapping in time domain. In such an example, the configuration may further include a bandwidth or a minimum bandwidth for the set of resources, and the bandwidth or the minimum bandwidth may be based on a precision specified for estimating the range between the wireless device and the IoT device. In such an example, the configuration may further include a number of times or a minimum number of times for which the FD-PDOA positioning is to be performed by the wireless device, and the number of times or the minimum number of times may be based on a positioning precision specified for estimating the range between the wireless device and the IoT device. In such an example, the configuration further may include a minimum bandwidth and a minimum time span for the set of resources, and the minimum bandwidth and the minimum time span may be based on a moving speed of the wireless device for maintaining a coherent bandwidth and a coherent time for the FD-PDOA positioning.

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the IoT device positioning configuration component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include a CU processor 2012. The CU processor 2012 may include on-chip memory 2012′. In some aspects, the CU 2010 may further include additional memory modules 2014 and a communications interface 2018. The CU 2010 communicates with the DU 2030 through a midhaul link, such as an F1 interface. The DU 2030 may include a DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include an RU processor 2042. The RU processor 2042 may include on-chip memory 2042′. In some aspects, the RU 2040 may further include additional memory modules 2044, one or more transceivers 2046, antennas 2080, and a communications interface 2048. The RU 2040 communicates with the UE 104. The on-chip memory 2012′, 2032′, 2042′ and the additional memory modules 2014, 2034, 2044 may each be considered a computer-readable medium/memory. Each computer-readable medium/memory may be non-transitory. Each of the processors 2012, 2032, 2042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the IoT device positioning configuration component 199 is configured to receive a set of requests from a wireless device for estimating a range between the wireless device and an IoT device or for estimating a position of the IoT device. The IoT device positioning configuration component 199 may also be configured to transmit or receive an indication indicating a positioning method for estimating the range between the wireless device and the IoT device or for estimating the position of the IoT device, where the indication is transmitted to or received from the wireless device. The IoT device positioning configuration component 199 may also be configured to transmit at least one response to the wireless device including a configuration for a set of resources for estimating the range between the wireless device and the IoT device or for estimating the position of the IoT device based on the set of requests and the indicated positioning method. The IoT device positioning configuration component 199 may be within one or more processors of one or more of the CU 2010, DU 2030, and the RU 2040. The IoT device positioning configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2002 may include a variety of components configured for various functions. As shown, the network entity 2002 may include a variety of components configured for various functions. In one configuration, the network entity 2002 includes means for receiving a set of requests from a wireless device for estimating a range between the wireless device and an IoT device or for estimating a position of the IoT device. The network entity 2002 may further include means for transmitting or means for receiving an indication indicating a positioning method for estimating the range between the wireless device and the IoT device or for estimating the position of the IoT device, where the indication is transmitted to or received from the wireless device. The network entity 2002 may further include means for transmitting at least one response to the wireless device including a configuration for a set of resources for estimating the range between the wireless device and the IoT device or for estimating the position of the IoT device based on the set of requests and the indicated positioning method.

In one example, the network entity 2002 may further include means for receiving a positioning precision specified for estimating the range between the wireless device and the IoT device or for estimating the position of the IoT device from the wireless device, and means for transmitting the indication indicating the positioning method to the wireless device based on the positioning precision specified.

In another example, each of the set of requests may be associated with the at least one response based on a timing window, an ID associated with the IoT device, a request ID associated with each of the set of requests, a response ID associated with the at least one response, or a combination thereof.

In another example, a number of requests in the set of requests or a periodicity between requests in the set of requests may be based on a moving speed of the wireless device. In such an example, the network entity 2002 may further include means for determining the periodicity based on the moving speed of the wireless device, and means for transmitting the determined periodicity to the wireless device.

In another example, the network entity 2002 may further include means for receiving a second indication of a moving speed or a position change of the wireless device from the wireless device, where the configuration for the set of resources may include a periodicity associated with the set of resources that is based on the moving speed or the position change.

In another example, the positioning method may include: ToA-based positioning, TDOA-based positioning, RSS-based positioning, PDOA-based positioning, or AoA-based positioning.

In another example, the positioning method may correspond to FD-PDOA positioning, and where the set of resources is non-overlapping in FD. In such an example, the network entity 2002 may further include means for receiving an estimated range between the wireless device and the IoT device from the wireless device, and means for estimating the position of the IoT device based on the estimated range.

In such an example, the set of resources may be further non-overlapping in time domain.

In such an example, the configuration may further include a bandwidth or a minimum bandwidth for the set of resources, and the bandwidth or the minimum bandwidth may be based on a positioning precision specified for estimating the range between the wireless device and the IoT device.

In such an example, the configuration may further include a number of times or a minimum number of times for which the FD-PDOA positioning is to be performed by the wireless device, and the number of times or the minimum number of times may be based on a positioning precision specified for estimating the range between the wireless device and the IoT device.

In such an example, the configuration further may include a minimum bandwidth and a minimum time span for the set of resources, and the minimum bandwidth and the minimum time span may be based on a moving speed of the wireless device for maintaining a coherent bandwidth and a coherent time for the FD-PDOA positioning.

The means may be the IoT device positioning configuration component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means. It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a wireless device, including: transmitting a set of requests to a network entity for estimating a range between the wireless device and an IoT device or for estimating a position of the IoT device; transmitting or receiving an indication indicating a positioning method for estimating the range between the wireless device and the IoT device or for estimating the position of the IoT device, where the indication is transmitted to or received from the network entity; and receiving at least one response from the network entity including a configuration for a set of resources for estimating the range between the wireless device and the IoT device or for estimating the position of the IoT device based on the set of requests and the indicated positioning method.

Aspect 2 is the method of aspect 1, further including: estimating the range between the wireless device and the IoT device or estimating the position of the IoT device using the indicated positioning method via the set of resources.

Aspect 3 is the method of aspect 1 or 2, further including: transmitting a positioning precision specified for estimating the range between the wireless device and the IoT device or for estimating the position of the IoT device to the network entity; and receiving the indication indicating the positioning method from the network entity based on the positioning precision specified.

Aspect 4 is the method of any of aspects 1 to 3, where the set of requests corresponds to one request for estimating the range between the wireless device and the IoT device, and where the set of requests corresponds to more than one request for estimating the position of the IoT device, the set of requests being non-overlapping in time domain.

Aspect 5 is the method of any of aspects 1 to 4, where each of the set of requests is associated with the at least one response based on a timing window, an ID associated with the IoT device, a request ID associated with each of the set of requests, a response ID associated with the at least one response, or a combination thereof.

Aspect 6 is the method of any of aspects 1 to 5, where a number of requests in the set of requests or a periodicity between requests in the set of requests is based on a moving speed of the wireless device.

Aspect 7 is the method of aspect 6, further including: determining the periodicity based on the moving speed of the wireless device; or receiving the periodicity from the network entity based on the moving speed of the wireless device.

Aspect 8 is the method of aspect 6, further including: refraining from estimating the range between the wireless device and the IoT device or estimating the position of the IoT device to the network entity if the moving speed of the wireless device exceeds a speed threshold.

Aspect 9 is the method of any of aspects 1 to 8, further including: transmitting a second set of requests to the network entity for estimating the range between the wireless device and the IoT device or for estimating the position of the IoT device if a position of the wireless device has changed its position for more than a distance threshold.

Aspect 10 is the method of any of aspects 1 to 9, further including: transmitting a second indication of a moving speed or a position change of the wireless device to the network entity, where the configuration for the set of resources includes a periodicity associated with the set of resources that is based on the moving speed or the position change.

Aspect 11 is the method of any of aspects 1 to 10, where the positioning method includes: ToA-based positioning, TDOA-based positioning, RSS-based positioning, PDOA-based positioning, or AoA-based positioning.

Aspect 12 is the method of any of aspects 1 to 11, where the positioning method corresponds to FD-PDOA positioning, and where the set of resources is non-overlapping in FD, the method further including: estimating the range between the wireless device and the IoT device based on FD-PDOA positioning using the set of resources.

Aspect 13 is the method of aspect 12, where estimating the range between the wireless device and the IoT device based on FD-PDOA positioning includes: transmitting a first set of signals to the IoT device; receiving a second set of signals backscattered from the IoT device; and measuring PDOA of the second set of signals

Aspect 14 is the method of aspect 13, further including: estimating the position of the IoT device based on the estimated range; or transmitting the estimated range to the network entity to assist the network entity in estimating the position of the IoT device

Aspect 15 is the method of aspect 14, where the set of resources is further non-overlapping in time domain.

Aspect 16 is the method of aspect 15, where the configuration further includes a bandwidth or a minimum bandwidth for the set of resources, and where the bandwidth or the minimum bandwidth is based on a positioning precision specified for estimating the range between the wireless device and the IoT device.

Aspect 17 is the method of aspect 16, where the configuration further includes a number of times or a minimum number of times for which the PDOA positioning is to be performed by the wireless device, and where the number of times or the minimum number of times is based on a positioning precision specified for estimating the range between the wireless device and the IoT device.

Aspect 18 is the method of aspect 17, where the configuration further includes a minimum bandwidth and a minimum time span for the set of resources, and where the minimum bandwidth and the minimum time span are based on a moving speed of the wireless device for maintaining a coherent bandwidth and a coherent time for the PDOA positioning.

Aspect 19 is an apparatus for wireless communication at a wireless device, including: a memory; and at least one processor coupled to the memory and, based at least in part on information stored in the memory, the at least one processor is configured to implement any of aspects 1 to 18.

Aspect 20 is the apparatus of aspect 19, further including at least one of a transceiver or an antenna coupled to the at least one processor.

Aspect 21 is an apparatus for wireless communication including means for implementing any of aspects 1 to 18.

Aspect 22 is a computer-readable medium (e.g., a non-transitory computer-readable medium) storing computer executable code, where the code when executed by a processor causes the processor to implement any of aspects 1 to 18.

Aspect 23 is a method of wireless communication at a network entity, including: receiving a set of requests from a wireless device for estimating a range between the wireless device and an IoT device or for estimating a position of the IoT device; transmitting or receiving an indication indicating a positioning method for estimating the range between the wireless device and the IoT device or for estimating the position of the IoT device, where the indication is transmitted to or received from the wireless device; and transmitting at least one response to the wireless device including a configuration for a set of resources for estimating the range between the wireless device and the IoT device or for estimating the position of the IoT device based on the set of requests and the indicated positioning method.

Aspect 24 is the method of aspect 23, further including: receiving a positioning precision specified for estimating the range between the wireless device and the IoT device or for estimating the position of the IoT device from the wireless device; and transmitting the indication indicating the positioning method to the wireless device based on the positioning precision specified.

Aspect 25 is the method of aspect 23 or aspect 24, where each of the set of requests is associated with the at least one response based on a timing window, an ID associated with the IoT device, a request ID associated with each of the set of requests, a response ID associated with the at least one response, or a combination thereof.

Aspect 26 is the method of any of aspects 23 to 25, where a number of requests in the set of requests or a periodicity between requests in the set of requests is based on a moving speed of the wireless device, the method further including: determining the periodicity based on the moving speed of the wireless device; and transmitting the determined periodicity to the wireless device.

Aspect 27 is the method of any of aspects 23 to 26, further including: receiving a second indication of a moving speed or a position change of the wireless device from the wireless device, where the configuration for the set of resources includes a periodicity associated with the set of resources that is based on the moving speed or the position change.

Aspect 28 is the method of any of aspects 23 to 27, where the positioning method includes: ToA-based positioning, TDOA-based positioning, RSS-based positioning, PDOA-based positioning, or AoA-based positioning.

Aspect 29 is the method of any of aspects 23 to 28, where the positioning method corresponds to FD-PDOA positioning, and where the set of resources is non-overlapping in FD.

Aspect 30 is the method of aspect 29, further including: receiving an estimated range between the wireless device and the IoT device from the wireless device; and estimating the position of the IoT device based on the estimated range.

Aspect 31 is the method of aspect 29, where the set of resources is further non-overlapping in time domain.

Aspect 32 is the method of aspect 29, where the configuration further includes a bandwidth or a minimum bandwidth for the set of resources, and where the bandwidth or the minimum bandwidth is based on a positioning precision specified for estimating the range between the wireless device and the IoT device.

Aspect 33 is the method of aspect 29, where the configuration further includes a number of times or a minimum number of times for which the FD-PDOA positioning is to be performed by the wireless device, and where the number of times or the minimum number of times is based on a positioning precision specified for estimating the range between the wireless device and the IoT device.

Aspect 34 is the method of aspect 29, where the configuration further includes a minimum bandwidth and a minimum time span for the set of resources, and where the minimum bandwidth and the minimum time span are based on a moving speed of the wireless device for maintaining a coherent bandwidth and a coherent time for the FD-PDOA positioning.

Aspect 35 is an apparatus for wireless communication at a network entity, including: a memory; and at least one processor coupled to the memory and, based at least in part on information stored in the memory, the at least one processor is configured to implement any of aspects 23 to 34.

Aspect 36 is the apparatus of aspect 35, further including at least one of a transceiver or an antenna coupled to the at least one processor.

Aspect 37 is an apparatus for wireless communication including means for implementing any of aspects 23 to 34.

Aspect 38 is a computer-readable medium (e.g., a non-transitory computer-readable medium) storing computer executable code, where the code when executed by a processor causes the processor to implement any of aspects 23 to 34.

1. An apparatus for wireless communication at a wireless device, comprising:
a memory; and
at least one processor coupled to the memory and, based at least in part on information stored in the memory, the at least one processor is configured to:
transmit a set of requests to a network entity for estimating a range between the wireless device and an Internet of Things (IoT) device or for estimating a position of the IoT device;
transmit, to the network entity, or receive, from the network entity, an indication indicating a positioning method for estimating the range between the wireless device and the IoT device or for estimating the position of the IoT device; and
receive at least one response from the network entity including a configuration for a set of resources for estimating the range between the wireless device and the IoT device or for estimating the position of the IoT device based on the set of requests and the indicated positioning method.

2. The apparatus of claim 1, wherein the at least one processor is further configured to:
estimate the range between the wireless device and the IoT device or estimate the position of the IoT device using the indicated positioning method via the set of resources.

3. The apparatus of claim 1, wherein the at least one processor is further configured to:
transmit a positioning precision specified for estimating the range between the wireless device and the IoT device or for estimating the position of the IoT device to the network entity; and
receive the indication indicating the positioning method from the network entity based on the positioning precision specified.

4. The apparatus of claim 1, wherein the set of requests corresponds to one request for estimating the range between the wireless device and the IoT device, and wherein the set of requests corresponds to more than one request for estimating the position of the IoT device, the set of requests being non-overlapping in time domain.

5. The apparatus of claim 1, wherein each of the set of requests is associated with the at least one response based on a timing window, an identification (ID) associated with the IoT device, a request ID associated with each of the set of requests, a response ID associated with the at least one response, or a combination thereof.

6. (canceled)

7. The apparatus of claim 1, wherein a number of requests in the set of requests or a periodicity between requests in the set of requests is based on a moving speed of the wireless device, wherein the at least one processor is further configured to:
determine the periodicity based on the moving speed of the wireless device or receiving the periodicity from the network entity based on the moving speed of the wireless device; and
refrain from estimating the range between the wireless device and the IoT device or estimating the position of the IoT device to the network entity if the moving speed of the wireless device exceeds a speed threshold.

8. The apparatus of claim 1, wherein the at least one processor is further configured to:
transmit a second set of requests to the network entity for estimating the range between the wireless device and the IoT device or for estimating the position of the IoT device if a position of the wireless device has changed its position for more than a distance threshold.

9. The apparatus of claim 1, wherein the at least one processor is further configured to:
transmit a second indication of a moving speed or a position change of the wireless device to the network entity, wherein the configuration for the set of resources includes a periodicity associated with the set of resources that is based on the moving speed or the position change.

10. The apparatus of claim 1, wherein the positioning method includes:
time of arrival (ToA) based positioning,
time difference of arrival (TDOA) based positioning,
received signal strength (RSS) based positioning,
phase difference of arrival (PDOA) based positioning, or
angle of arrival (AoA) based positioning.

11. The apparatus of claim 1, wherein the positioning method corresponds to frequency domain (FD)-phase difference of arrival (PDOA) (FD-PDOA) positioning, and wherein the set of resources is non-overlapping in FD, the at least one processor is configured to:
estimate the range between the wireless device and the IoT device based on the FD-PDOA positioning using the set of resources.

12. The apparatus of claim 11, wherein to estimate the range between the wireless device and the IoT device based on the FD-PDOA positioning, the at least one processor is configured to:
transmit a first set of signals to the IoT device;
receive a second set of signals backscattered from the IoT device; and
measure PDOA of the second set of signals.

13. (canceled)

14. (canceled)

15. (canceled)

16. The apparatus of claim 11, wherein the configuration further includes a number of times or a minimum number of times for which the FD-PDOA positioning is to be performed by the wireless device, and wherein the number of times or the minimum number of times is based on a positioning precision specified for estimating the range between the wireless device and the IoT device.

17. (canceled)

18. (canceled)

19. An apparatus for wireless communication at a network entity, comprising:
a memory; and
at least one processor coupled to the memory and, based at least in part on information stored in the memory, the at least one processor is configured to:
receive a set of requests from a wireless device for estimating a range between the wireless device and an Internet of Things (IoT) device or for estimating a position of the IoT device;
transmit, for the wireless device, or receive, from the wireless device, an indication indicating a positioning method for estimating the range between the wireless device and the IoT device or for estimating the position of the IoT device; and
transmit at least one response to the wireless device including a configuration for a set of resources for estimating the range between the wireless device and the IoT device or for estimating the position of the IoT device based on the set of requests and the indicated positioning method.

20. The apparatus of claim 19, wherein the at least one processor is further configured to:
receive a positioning precision specified for estimating the range between the wireless device and the IoT device or for estimating the position of the IoT device from the wireless device; and
transmit the indication indicating the positioning method to the wireless device based on the positioning precision specified.

21. The apparatus of claim 19, wherein each of the set of requests is associated with the at least one response based on a timing window, an identification (ID) associated with the IoT device, a request ID associated with each of the set of requests, a response ID associated with the at least one response, or a combination thereof.

22. The apparatus of claim 19, wherein a number of requests in the set of requests or a periodicity between requests in the set of requests is based on a moving speed of the wireless device, wherein the at least one processor is further configured to:
determine the periodicity based on the moving speed of the wireless device; and
transmit the determined periodicity to the wireless device.

23. (canceled)

24. The apparatus of claim 19, wherein the positioning method includes:
time of arrival (ToA) based positioning,
time difference of arrival (TDOA) based positioning,
received signal strength (RSS) based positioning,
phase difference of arrival (PDOA) based positioning, or
angle of arrival (AoA) based positioning.

25. The apparatus of claim 19, wherein the positioning method corresponds to frequency domain (FD)-phase difference of arrival (PDOA) (FD-PDOA) positioning, and wherein the set of resources is non-overlapping in FD.

26. (canceled)

27. (canceled)

28. (canceled)

29. The apparatus of claim 25, wherein the configuration further includes a minimum bandwidth and a minimum time span for the set of resources, and wherein the minimum bandwidth and the minimum time span are based on a moving speed of the wireless device for maintaining a coherent bandwidth and a coherent time for the FD-PDOA positioning.

30. A method of wireless communication at a network entity, comprising:
receiving a set of requests from a wireless device for estimating a range between the wireless device and an Internet of Things (IoT) device or for estimating a position of the IoT device;
transmitting, for the wireless device, or receiving, from the wireless device, an indication indicating a positioning method for estimating the range between the wireless device and the IoT device or for estimating the position of the IoT device; and
transmitting at least one response to the wireless device including a configuration for a set of resources for estimating the range between the wireless device and the IoT device or for estimating the position of the IoT device based on the set of requests and the indicated positioning method.
